(19) United States
(12) Patent Application Publication
(10) Pub. No.: US 2025/0200841 A1
(43) Pub. Date: Jun. 19, 2025

(54) PREFERENCE ESTIMATION METHOD, PREFERENCE ESTIMATION APPARATUS, PREFERENCE ESTIMATION PROGRAM, DISPLAY METHOD, MODEL GENERATION METHOD, AND PREFERENCE INFORMATION PREDICTION METHOD

(71) Applicant: AJINOMOTO CO., INC., Tokyo (JP)

(72) Inventors: Chinatsu KASAMATSU, Kanagawa (JP); Koichi ISE, Kanagawa (JP); Yusuke IHARA, Kanagawa (JP); Gakuro IKEDA, Kanagawa (JP); Yoshihito NOGUSA, Kanagawa (JP)

(73) Assignee: AJINOMOTO CO., INC., Tokyo (JP)

(21) Appl. No.: 19/070,874

(22) Filed: Mar. 5, 2025

Related U.S. Application Data
(63) Continuation of application No. PCT/JP2023/032804, filed on Sep. 8, 2023.

(30) Foreign Application Priority Data
Sep. 9, 2022 (JP) 2022-143854

(51) Int. Cl. G06T 11/20

(52) U.S. Cl. CPC G06T 11/206

(57) ABSTRACT

A preference estimation method includes (1) a model generating step of generating, using preference information as information representing a preference of a person for an object, a preference space model as a model that includes a plurality of points each representing the object and a plurality of points each representing the person in a three-dimensional space and represents that a preference of the person for the object is higher as a distance between the point representing the object and the point representing the person is shorter, and (2) an object estimating step of estimating, using the preference information about a preference estimation person as a person whose preference is estimated, an object for which the preference estimation person has a high preference, based on the preference space model.

### CROSS-REFERENCE TO RELATED APPLICATION

This application is based upon and claims the benefit of priority from PCT Application PCT/JP2023/032804, filed Sep. 8, 2023, which claims priority from Japanese Patent Application No. 2022-143854, filed Sep. 9, 2022, the entire contents of which are incorporated herein by reference.

### BACKGROUND OF THE INVENTION

### 1. Field of the Invention

The present invention relates to a preference estimation method, a preference estimation apparatus, a preference estimation program, a display method, a model generation method, and a preference information prediction method.

### 2. Description of the Related Art

JP-A-2021-189976 discloses a food recipe recommendation system and the like that can easily generate a food corresponding to a related article related to the food (refer to the paragraph 0004 and the like in JP-A-2021-189976). WO2020/027281 discloses an information presentation method and the like that can present a food with a taste preferred by a user while considering a temporal change of the taste of the food (refer to the paragraph 0008 and the like in WO2020/027281).

As described in JP-A-2021-189976 and WO2020/027281, a technique of suggesting a food suitable for a preference of a certain person has been developed in recent years, but there is the problem that accuracy of suggestion is low, for example.

### SUMMARY OF THE INVENTION

It is an object of the present invention to at least partially solve the problems in the conventional technology.

The present invention is made in view of the problem, and aims at providing a preference estimation method, a preference estimation apparatus, a preference estimation program, and the like that can estimate an object (for example, a food) suitable for a preference of a certain person by using a preference space model that includes a plurality of points each representing an object (for example, a food) and a plurality of points each representing a person in a three-dimensional space.

In order to solve the problem and achieve the object, a preference estimation method according to one aspect of the present disclosure includes (1) a model generating step of generating, using preference information as information representing a preference of a person for an object, a preference space model as a model that includes a plurality of points each representing the object and a plurality of points each representing the person in a three-dimensional space and represents that a preference of the person for the object is higher as a distance between the point representing the object and the point representing the person is shorter, and (2) an object estimating step of estimating, using the preference information about a preference estimation person as a person whose preference is estimated, an object for which the preference estimation person has a high preference, based on the preference space model.

In the preference estimation method according to one aspect of the present disclosure, the points each representing the person are classified into a plurality of groups in the preference space model, and at the object estimating step, a group having a highest correlation with the preference of the preference estimation person is specified from the groups using the preference information about the preference estimation person, and an object for which the specified group has a high preference is estimated to be the object for which the preference estimation person has a high preference.

The preference estimation method according to one aspect of the present disclosure, further includes (3) a correlation calculating step of calculating a correlation between the point representing the object in the preference space model and objective information as objective information about the object and (4) a person estimating step of estimating, using the objective information about a preference estimation object as an object as a target for estimating a person who prefers the object, a person who prefers the preference estimation object, based on the correlation and the preference space model. There is also the problem that a food can be suggested but a person who prefers a certain food cannot be estimated, with techniques described in JP-A-2021-189976 and WO2020/027281. The preference estimation method according to one aspect of the present disclosure can estimate a person who prefers a certain object (for example, a food) by using the preference space model.

In the preference estimation method according to one aspect of the present disclosure, the points each representing the person are classified into a plurality of groups, and space coordinates of a centroid of each of the groups are obtained in the preference space model, and at the person estimating step, space coordinates of a point representing the preference estimation object in the preference space model are obtained based on the correlation using the objective information about the preference estimation object, a group with a centroid having the shortest distance to the obtained space coordinates is specified from the groups, and a person belonging to the specified group is estimated to be a person who prefers the preference estimation object.

In the preference estimation method according to one aspect of the present disclosure, the objective information is at least one selected from the group consisting of a sense characteristic, a nutrient component, a physical characteristic, a biological characteristic, and a sociocultural characteristic of the object.

The preference estimation method according to one aspect of the present disclosure, further includes an attribute/food consciousness presenting step of presenting at least one of attribute information as information about an attribute of the person belonging to the specified group, and food consciousness information as information about food consciousness of the person belonging to the specified group.

In the preference estimation method according to one aspect of the present disclosure, the attribute information is at least one selected from the group consisting of gender, an age, a place of residence, an economic situation, a health situation, household members, a marital status, presence/absence of a child, a school carrier, a knowledge level, a religion and an attitude, a belief, genetic information, disease information, a purchase history, a use situation of SNS, a job, nationality, a hometown, migration history information, a hobby, a homepage browse and communication history, tax payment information, vital information (invasive, noninvasive), amino index information (registered trademark), and an income.

In the preference estimation method according to one aspect of the present disclosure, the preference information is a result of a questionnaire that examines the preference of the person for the object as a score.

In the preference estimation method according to one aspect of the present disclosure, the object is a food.

In the preference estimation method according to one aspect of the present disclosure, the food is a vegetable, a seasoning, a processed food, or a beverage.

A preference estimation apparatus according to one aspect of the present disclosure includes a control unit. The control unit includes (1) a model generating unit that generates, using preference information as information representing a preference of a person for an object, a preference space model as a model that includes a plurality of points each representing the object and a plurality of points each representing the person in a three-dimensional space and represents that a preference of the person for the object is higher as a distance between the point representing the object and the point representing the person is shorter, and (2) an object estimating unit that estimates, using the preference information about a preference estimation person as a person whose preference is estimated, an object for which the preference estimation person has a high preference, based on the preference space model.

In the preference estimation apparatus according to one aspect of the present disclosure, the control unit further includes (3) a correlation calculating unit that calculates a correlation between the point representing the object in the preference space model and objective information as objective information about the object, and (4) a person estimating unit that estimates, using the objective information about a preference estimation object as an object as a target for estimating a person who prefers the object, a person who prefers the preference estimation object, based on the correlation and the preference space model.

A preference estimation program according to one aspect of the present disclosure is a preference estimation program to be executed by an information processing apparatus including a control unit. The preference estimation program according to one aspect of the present disclosure includes (1) a model generating step of generating, using preference information as information representing a preference of a person for an object, a preference space model as a model that includes a plurality of points each representing the object and a plurality of points each representing the person in a three-dimensional space and represents that a preference of the person for the object is higher as a distance between the point representing the object and the point representing the person is shorter, and (2) an object estimation step of estimating, using the preference information about a preference estimation person as a person whose preference is estimated, an object for which the preference estimation person has a high preference, based on the preference space model. The steps are performed by the information processing apparatus.

The preference estimation program according to one aspect of the present disclosure, further includes (3) a correlation calculating step of calculating a correlation between the point representing the object in the preference space model and objective information as objective information about the object, and (4) a person estimating step of estimating, using the objective information about a preference estimation object as an object as a target for estimating a person who prefers the object, a person who prefers the preference estimation object based on the correlation and the preference space model. The steps are performed by the information processing apparatus.

A preference estimation method according to one aspect of the present disclosure includes (1) a preference information acquiring step of acquiring preference information as information representing a preference of a person for an object about a preference estimation person as a person whose preference is estimated, and (2) an object estimating step of estimating an object for which the preference estimation person has a high preference using the preference information about the preference estimation person acquired at the preference information acquiring step based on a preference space model generated by using preference information as information representing a preference of a person for an object, the preference space model including a plurality of points each representing the object and a plurality of points each representing the person in a three-dimensional space and representing that the preference of the person for the object is higher as a distance between the point representing the object and the point representing the person is shorter.

A preference estimation method according to one aspect of the present disclosure includes (1) a correlation calculating step of calculating, based on a preference space model generated by using preference information as information representing a preference of a person for an object, the preference space model including a plurality of points each representing the object and a plurality of points each representing the person in a three-dimensional space and representing that the preference of the person for the object is higher as a distance between the point representing the object and the point representing the person is shorter, a correlation between a point representing the object in the preference space model and objective information as objective information about the object, and (2) a person estimating step of estimating, using the objective information about a preference estimation object as an object as a target for estimating a person who prefers the object, a person who prefers the preference estimation object based on the correlation and the preference space model.

A preference estimation method according to one aspect of the present disclosure includes an object estimating step of estimating, based on a preference space model generated by using preference information as information representing a preference of a person for an object, the preference space model including a plurality of points each representing the object and a plurality of points each representing the person in a three-dimensional space and representing that the preference of the person for the object is higher as a distance between the point representing the object and the point representing the person is shorter using preference information about a preference estimation person as a person whose preference is estimated, an object for which the preference estimation person has a high preference.

A display method according to one aspect of the present disclosure, is with a preference space model generated by using preference information as information representing a preference of a person for an object, the preference space model including a plurality of points each representing the object and a plurality of points each representing the person in a three-dimensional space and representing that the preference of the person for the object is higher as a distance between the point representing the object and the point representing the person is shorter, in which 1) the points each representing the person are classified into a plurality of groups, 2) space coordinates of a centroid of each of the groups are obtained, and 3) a correlation between the point representing the object and objective information as objective information about the object is calculated. The display method according to one aspect of the present disclosure includes (1) a person estimating step of obtaining, using the objective information about a preference estimation object as an object as a target for estimating a person who prefers the object, space coordinates of a point representing the preference estimation object in the preference space model based on the correlation, specifying a group with a centroid having the shortest distance to the obtained space coordinates from the groups, and estimating a person belonging to the specified group as a person who prefers the preference estimation object, and (2) an attribute/food consciousness presenting step of presenting at least one of attribute information as information about an attribute of the person belonging to the specified group, and food consciousness information as information about food consciousness of the person belonging to the specified group.

A model generation method according to one aspect of the present disclosure includes a model generating step of generating, using preference information as information representing a preference of a person for an object, a preference space model that includes a plurality of points each representing the object and a plurality of points each representing the person in a three-dimensional space and represents that a preference of the person for the object is higher as a distance between the point representing the object and the point representing the person is shorter.

A preference information prediction method according to one aspect of the present disclosure is with a machine learning model that predicts, from preference information as information representing a preference of a person for an object corresponding to each of some multiple types of objects among multiple types of predetermined objects, the preference information corresponding to each of multiple types of residual objects other than some multiple types of objects, the machine learning model being generated based on a supervised learning method using the preference information corresponding to each of the multiple types of predetermined objects. The preference information prediction method according to one aspect of the present disclosure includes a preference information predicting step of predicting the preference information about a preference estimation person as a person whose preference is estimated corresponding to each of the multiple types of residual objects using the preference information about the preference estimation person corresponding to each of some multiple types of objects.

A model generation method according to one aspect of the present disclosure includes (1) an object selecting step of selecting some multiple types of objects from multiple types of predetermined objects, and (2) a model generating step of generating, based on a supervised learning method, a machine learning model that predicts preference information corresponding to each of multiple types of residual objects other than the selected objects from the preference information about each of the objects selected at the object selecting step using the preference information as information representing a preference of a person for an object corresponding to each of the multiple types of predetermined objects.

The model generation method according to one aspect of the present disclosure, further includes (3) an MAE calculating step of calculating a mean absolute error with respect to a prediction result obtained by the machine learning model generated at the model generating step assuming that the preference information corresponding to each of the multiple types of residual objects is a correct answer. Multiple types of objects are selected in descending order of the mean absolute error at the object selecting step.

The model generation method according to one aspect of the present disclosure, further includes (4) a correlation coefficient calculating step of calculating a correlation coefficient of the preference information for each pair of objects using the preference information corresponding to each of the multiple types of predetermined objects. Multiple types of objects are selected in ascending order of the correlation coefficient at the object selecting step.

The model generation method according to one aspect of the present disclosure, further includes (4) a correlation coefficient calculating step of calculating a correlation coefficient of the preference information for each pair of objects using the preference information corresponding to each of the multiple types of predetermined objects. Multiple types of objects are selected at the object selecting step by selecting multiple types of objects in descending order of the mean absolute error, selecting a pair of objects from the selected objects in descending order of the correlation coefficient, and excluding an object having a smaller mean absolute error from the selected pair of objects.

In the model generation method according to one aspect of the present disclosure, attribute information as information about an attribute of a person is used in generating the machine learning model at the model generating step.

The model generation method according to one aspect of the present disclosure, further includes (5) a sensitivity map creating step of creating a sensitivity map of a preference space model generated by using preference information as information representing a preference of a person for an object, the preference space model including a plurality of points each representing the object and a plurality of points each representing the person in a three-dimensional space and representing that the preference of the person for the object is higher as a distance between the point representing the object and the point representing the person is shorter. The attribute information used in generating the machine learning model at the model generating step is gender and an age. Multiple types of objects are selected at the object selecting step by selecting an object to be excluded based on the sensitivity map, selecting multiple types of objects in descending order of the mean absolute error from the multiple types of predetermined objects from which the selected object has been excluded, selecting a pair of objects in descending order of the correlation coefficient from the selected objects, and excluding an object having a smaller mean absolute error from the selected pair of objects.

In the model generation method according to one aspect of the present disclosure, the supervised learning method corresponds to classification.

In the model generation method according to one aspect of the present disclosure, the supervised learning method corresponds to a method of decision tree.

In the model generation method according to one aspect of the present disclosure, the supervised learning method uses a method of gradient boosting.

In the model generation method according to one aspect of the present disclosure, the supervised learning method is a Light Gradient Boosting Machine (LightGBM).

The present disclosure exhibits an effect of estimating an object (for example, a food) suitable for a preference of a certain person by using a preference space model that includes a plurality of points each representing an object (for example, a food) and a plurality of points each representing a person in a three-dimensional space.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of an example of a configuration of a preference estimation apparatus;

FIG. 2 is a diagram of an example of a flow of preference estimation according to an embodiment;

FIG. 3 is a diagram of 40 types of vegetables as subjects of a questionnaire;

FIG. 4 is a diagram of 23 types of sense characteristics used for calculating a correlation;

FIG. 5 is a diagram of 51 types of nutrient components used for calculating a correlation;

FIG. 6 is a diagram of questions used for the questionnaire;

FIG. 7 is a diagram of candidates for answers to Q1 (question about preferences for vegetables) in the questionnaire;

FIG. 8 is a graph representing average values (preference average values) of answers to Q1 about the 40 types of vegetables;

FIG. 9 is a graph representing distribution (preference distribution) of answers to Q1 about a potato, a heated Japanese radish, a sweet potato, a heated onion, and a heated Chinese cabbage;

FIG. 10 is a graph representing distribution (preference distribution) of answers to Q1 about a Welsh onion, corn, a heated cabbage, an eggplant, and a lettuce;

FIG. 11 is a graph representing distribution (preference distribution) of answers to Q1 about a pumpkin, a raw yam, a raw tomato, a raw cabbage, and a bamboo shoot;

FIG. 12 is a graph representing distribution (preference distribution) of answers to Q1 about heated spinach, a taro, a lotus root, a cucumber, and a heated yam.

FIG. 13 is a graph representing distribution (preference distribution) of answers to Q1 about a burdock root, a shiitake mushroom, asparagus, bean sprouts, and a raw Japanese radish;

FIG. 14 is a graph representing distribution (preference distribution) of answers to Q1 about a shimeji mushroom, broccoli, Chinese chives, a green pepper, and an enoki mushroom;

FIG. 15 is a graph representing distribution (preference distribution) of answers to Q1 about a heated carrot, a raw onion, a raw Chinese cabbage, raw spinach, and Japanese mustard spinach;

FIG. 16 is a graph representing distribution (preference distribution) of answers to Q1 about a raw turnip, a heated turnip, pak choi, a raw carrot, and celery;

FIG. 17 is a graph representing a result of answers of “0 points (I don't know because I have never eaten it)” to Q1 about the 40 types of vegetables;

FIG. 18 is a diagram of a generated preference space model;

FIG. 19 is a diagram of the generated preference space model representing a degree of an error in an answer for a vegetable if there is the error;

FIG. 20 is a diagram of correlations between the vegetables and answer results for Q2 (a question about the 23 types of sense characteristics) in the questionnaire indicated by arrows on the preference space model;

FIG. 21 is a diagram of correlation coefficients between the vegetables and answer results for Q2 (a question about the 23 types of sense characteristics) in the questionnaire;

FIG. 22 is a diagram of correlations between nutrient components and the vegetables indicated by arrows on the preference space model;

FIG. 23 is a diagram of correlation coefficients between the nutrient components and the vegetables;

FIG. 24 is a graph representing contribution ratios of respective components;

FIG. 25 is a graph generated by plotting results obtained by a CATA method;

FIG. 26 is a graph representing a relation between Team Liking and the number of divisions (the number of preference groups) when people in the preference space model are divided into a certain number of groups;

FIG. 27 is a diagram of the number of people in each group (Cluster Size) and Team Liking when the people in the preference space model are divided;

FIG. 28 is a diagram of centroids of respective groups indicated on the preference space model;

FIG. 29 is a diagram of average values of answers of seven groups to Q1 (a question about a preference for a vegetable) in the questionnaire indicated for vegetables of V01 to V20;

FIG. 30 is a diagram of average values of answers of the seven groups to Q1 (a question about a preference for a vegetable) in the questionnaire indicated for vegetables of V21 to V40;

FIG. 31 is a graph representing appearance frequencies of sense characteristics answered by groups of LO1 to LO4 as to a preferred vegetable in response to Q2 (a question about the 23 types of sense characteristics) in the questionnaire;

FIG. 32 is a graph representing appearance frequencies of sense characteristics answered by groups of LO5 to LO7 as to a preferred vegetable in response to Q2 (a question about the 23 types of sense characteristics) in the questionnaire;

FIG. 33 is a graph representing amounts of nutrient components related to vegetables preferred by the groups of LO1 to LO4;

FIG. 34 is a graph representing amounts of nutrient components related to vegetables preferred by the groups of LO5 to LO7;

FIG. 35 is a graph representing amounts of part of nutrient components related to vegetables preferred by the groups of LO1 to LO4;

FIG. 36 is a graph representing amounts of part of nutrient components related to vegetables preferred by the groups of LO5 to LO7;

FIG. 37 is a graph representing an examination result about the genders in each group;

FIG. 38 is a graph representing an examination result about an age of each group;

FIG. 39 is a graph representing an examination result about a marital status of each group;

FIG. 40 is a graph representing an examination result about an annual household income of each group;

FIG. 41 is a graph representing a ratio of people who are particular about selecting food items and cooking in each group;

FIG. 42 is a graph representing a ratio of people who use pesticide-free and organic agricultural products by choice in each group;

FIG. 43 is a graph representing a ratio of people who purchase a topical product in each group;

FIG. 44 is a graph representing a ratio of people who are interested in tasty restaurants in each group;

FIG. 45 is a graph representing a ratio of people who have purchased a perishable product via the Internet in each group;

FIG. 46 is a graph representing a ratio of people who want to eat many vegetables in each group;

FIG. 47 is a graph representing a ratio of people who willingly collect information in each group;

FIG. 48 is a diagram of correlation coefficients and the like of 23 people each having a high correlation with a preference estimation person;

FIG. 49 is a diagram of groups to which the 23 people each having a high correlation with the preference estimation person belong;

FIG. 50 is a diagram of space coordinates of points representing four types of vegetables that are not subjects of the questionnaire;

FIG. 51 is a diagram of space coordinates of centroids of seven groups;

FIG. 52 is a diagram of centroids of the respective groups indicated on the preference space model;

FIG. 53 is a diagram of distances between the centroids of the seven groups and the points representing the four types of vegetables that are not the subjects of the questionnaire;

FIG. 54 is a diagram of an example of a method of simplifying the questionnaire about the 40 types of vegetables into a questionnaire about 10 types of vegetables;

FIG. 55 is a diagram of an example of a method of simplifying the questionnaire about 40 types of vegetables into a questionnaire about 20 types of vegetables;

FIG. 56 is a diagram of accuracy of a prediction result of a preference group when the questionnaire is shortened;

FIG. 57 is a diagram of a list of accuracy;

FIG. 58 is a diagram of a confusion matrix visualizing distribution of differences between prediction and correct answers;

FIG. 59 is a diagram of a confusion matrix visualizing distribution of differences between prediction and correct answers;

FIG. 60 is a diagram of a confusion matrix visualizing distribution of differences between prediction and correct answers;

FIG. 61 is a diagram of a confusion matrix visualizing distribution of differences between prediction and correct answers;

FIG. 62 is a diagram of a confusion matrix visualizing distribution of differences between prediction and correct answers;

FIG. 63 is a diagram of a confusion matrix visualizing distribution of differences between prediction and correct answers;

FIG. 64 is a diagram of a sensitivity map; and

FIG. 65 is a diagram of a confusion matrix visualizing distribution of differences between prediction and correct answers.

### DETAILED DESCRIPTION OF THE PREFERRED EMBODIMENTS

The following describes an embodiment of a preference estimation method, a preference estimation apparatus, a preference estimation program, a display method, a model generation method, and a preference information prediction method in detail based on the drawings. The present invention is not limited to the present embodiment.

### 1. Configuration

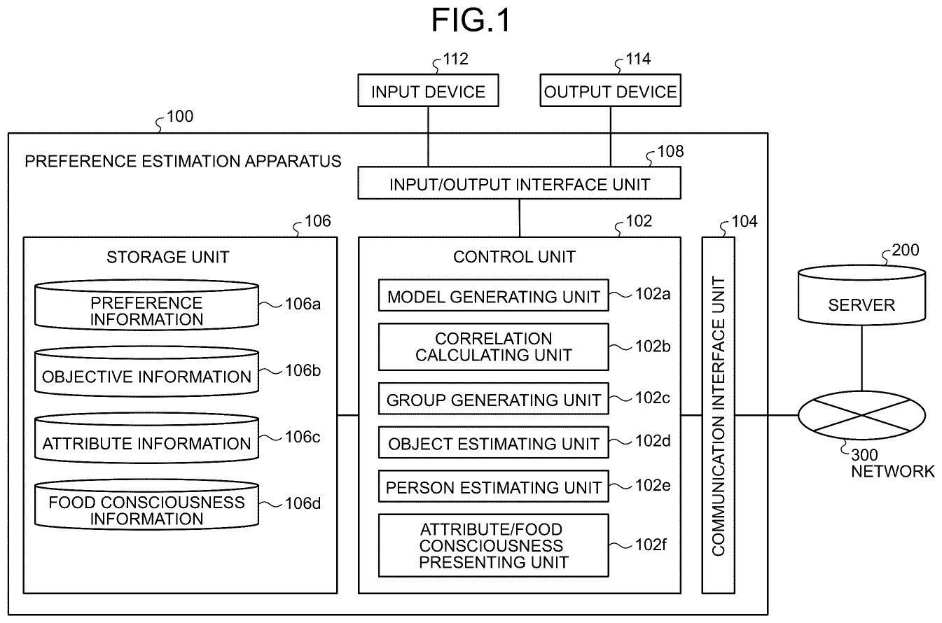

The following describes an example of a configuration of a preference estimation apparatus 100 according to the present embodiment with reference to FIG. 1. FIG. 1 is a block diagram of an example of the configuration of the preference estimation apparatus 100.

The preference estimation apparatus 100 is a commercially available desktop personal computer. The preference estimation apparatus 100 is not limited to a stationary information processing apparatus such as a desktop personal computer, but may be a portable information processing apparatus such as a notebook-type personal computer, personal digital assistants (PDA), a smartphone, or a tablet personal computer that is commercially available.

The preference estimation apparatus 100 includes a control unit 102, a communication interface unit 104, a storage unit 106, and an input/output interface unit 108. The units included in the preference estimation apparatus 100 are connected to be able to communicate with each other via an optional communication channel.

The communication interface unit 104 connects the preference estimation apparatus 100 to a network 300 in a communicable manner via a communication device such as a router and a wired or wireless communication line such as a private line. The communication interface unit 104 has a function of communicating data with another device via a communication line. The network 300 has a function of connecting the preference estimation apparatus 100 to a server 200 to be able to communicate with each other. The network 300 is, for example, the Internet or a local area network (LAN).

An input device 112 and an output device 114 are connected to the input/output interface unit 108. As the output device 114, not only a monitor (including a home television) but also a speaker or a printer can be used. As the input device 112, not only a keyboard, a mouse, and a microphone but also a monitor that implements a pointing device function in cooperation with a mouse can be used. In the following description, the output device 114 may be described as a monitor 114, and the input device 112 may be described as a keyboard 112 or a mouse 112.

The storage unit 106 stores various databases, tables, files, and the like. In the storage unit 106, a computer program is recorded for performing various kinds of processing by giving commands to a central processing unit (CPU) in cooperation with an operating system (OS). As the storage unit 106, for example, a memory device such as a random access memory (RAM) and a read only memory (ROM), a fixed disk device such as a hard disk, a flexible disk, and an optical disc can be used.

The storage unit 106 includes, for example, preference information 106a, objective information 106b, attribute information 106c, and food consciousness information 106d.

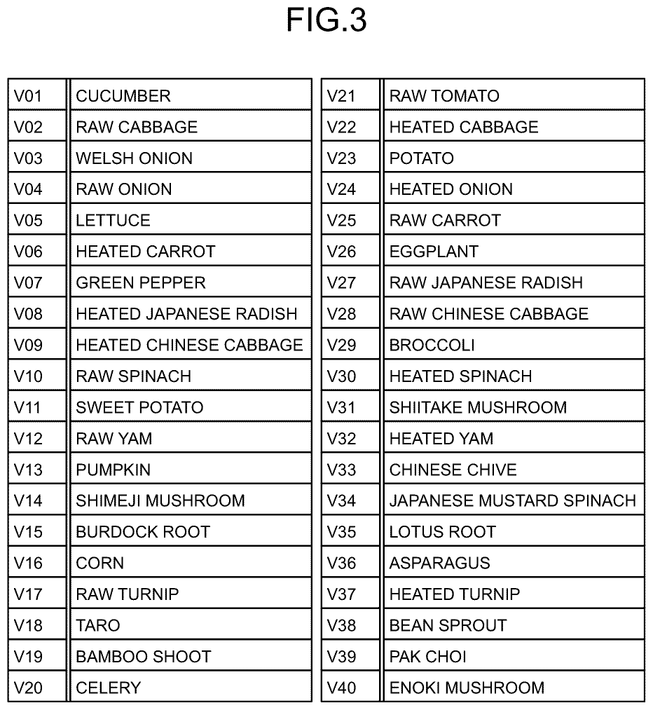

In the present embodiment, an object may be any object so long as a preference for which depends on a person. The object is an object desired to be recommended, suggested, or sold, for example. The object is, for example, a food, a beverage, clothes, a house, furniture, a household electrical appliance, or a car, and is preferably a food. The food is, for example, a vegetable. Examples of the vegetable include 40 types of vegetables illustrated in FIG. 3.

A type of the food is not limited so long as preference estimation for which is desired. The food encompasses grain, vegetables, meat, seafood, eggs, and dairy products. The food also encompasses beverages. The food also encompasses seasonings. The food also encompasses processed foods. The food may be, for example, liquid or a solid. Specific examples of the food include: beverages such as milk, soft drinks, alcoholic beverages, and soup; dairy products such as butter, ice cream, yogurt, cheese, and whey; meat processed food such as ham, sausage, a meat dumpling, a shaomai, a hamburg steak, deep-fried chicken, and a deep-fried pork cutlet; fishery processed food such as salmon flakes, karashi-mentaiko, salted cod roe, roast fishes, dried fishes, salted fish-guts, fish sausage, boiled fish paste, boiled fish, tsukudani, and canned foods; snacks such as potato chips, potato snacks, corn snacks, flour snacks, cinnamon cookies, rice crackers, and rice-cake cubes; noodle soup such as udon soup, soba soup, somen soup, ramen soup, chanpon soup, and pasta sauce; rice cooked food such as rice balls, pilaf, fried rice, mixed rice, rice gruel, and ochazuke; boiled foods such as a curry, a stew, chili con carne, feijoada, and mapo tofu; roux such as stew roux and curry roux; vegetable processed food such as kimchi and pickles; other processed food such as bread, noodles, a gratin, a croquette, and mashed potatoes; sauce such as Chinese sauce, oyster sauce, cheese sauce, tomato sauce, white sauce, demiglace sauce, curry sauce, Genoa sauce, chili sauce, and Tabasco sauce; seasoning oil such as Chinese chili oil; basic seasonings such as soy sauce and miso; flavor seasonings such as a bonito flavor, a chicken flavor, a pork flavor, and a beef flavor; pungent seasonings such as shichimi togarashi, doubanjiang, and gochujang; seasonings for menus (dedicated seasoning for a menu to be cooked); and other seasonings such as dressing, miso, mayonnaise, tomato ketchup, and consomme. The “soft drink” may mean a non-alcoholic beverage (beverage with alcohol concentration lower than 1%) excluding milk and dairy products. Specific examples of the soft drink include water, fruit juice, tea (chai, cinnamon tea, and the like), tea beverages, coffee beverages (coffee, milk beverages containing coffee, and the like), carbonated beverages (ginger ale, lemon carbonated beverages, and the like,), and sport drinks. Specific examples of the soup include dhal soup, tom yam kung, egg-containing soup, wakame-seaweed-containing soup, shark's fin-containing soup, Chinese soup, consomme soup, curry flavored soup, Japanese clear soup, miso soup, and potage soup. The food encompasses not only general foods but also what is called healthy foods or medical foods such as a nutritional supplementary food (supplement), a functional nutritional food, and a designated health food.

The preference information 106a is information representing a preference of a person for the object, and is a result of a questionnaire for examining the preference of the person for the object as a score, for example. The number of objects is, for example, equal to or more than 5, preferably equal to or more than 10, more preferably equal to or more than 30, and even more preferably equal to or more than 40.

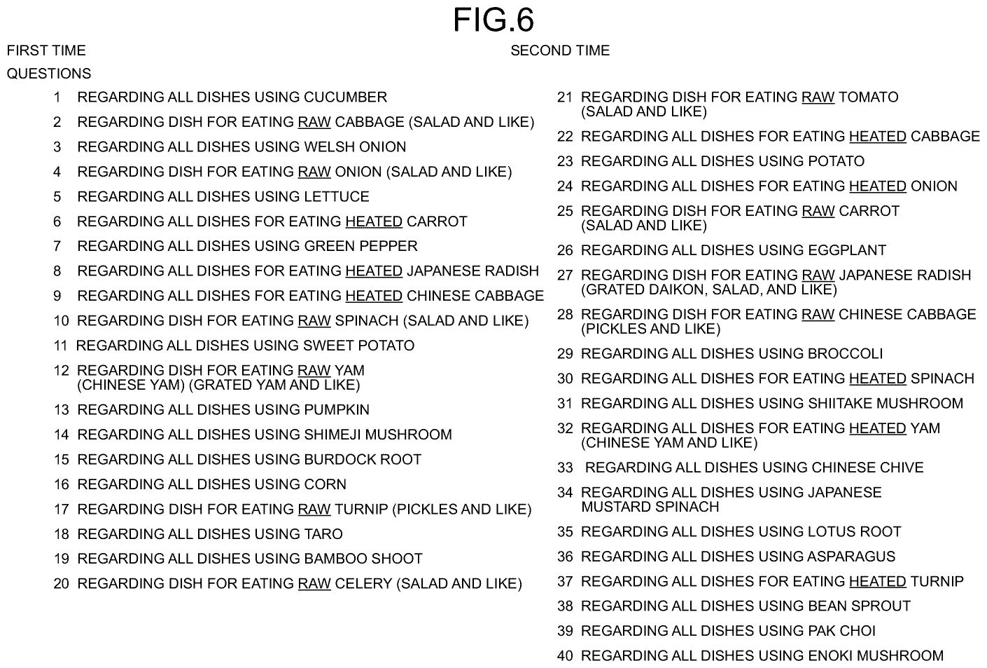

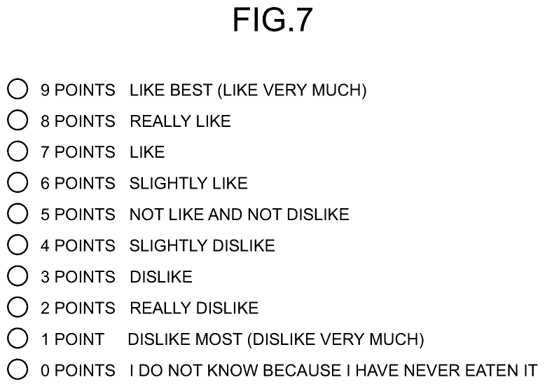

The result is, for example, a result obtained when a respondent answers to a question of Q1 “How much do you like? Please answer while imagining a representative dish.” for each of the 40 types of vegetables illustrated in FIG. 6 with nine ranks from “1 point (dislike the best) to 9 points (like the best)” illustrated in FIG. 7. An answer of the respondent is represented by, for example, three ranks or more, preferably five ranks or more, more preferably seven ranks or more, and even more preferably nine ranks or more.

The objective information 106b is objective information about the object, and is at least one selected from the group consisting of a sense characteristic, a nutrient component, a physical characteristic, a biological characteristic, a sociocultural characteristic, and other proper information of the object, for example.

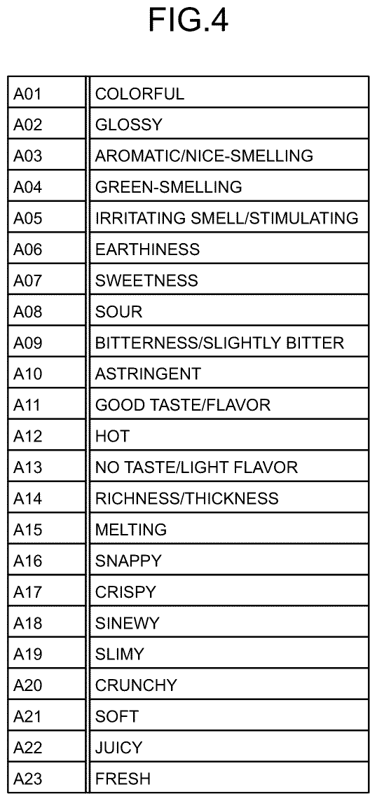

The sense characteristic is, for example, a result obtained when the respondent selects a specific word from words in a list in response to a question of “Please select all appropriate characteristics for this object from the following word list (multiple selection is allowed).” for each of the objects. The sense characteristic is, for example, a result obtained when the respondent selects a specific word from words in a list illustrated in FIG. 4 in response to a question of Q2 “Please select all appropriate characteristics for this vegetable from the following word list (multiple selection is allowed).” for each of the 40 types of vegetables illustrated in FIG. 6.

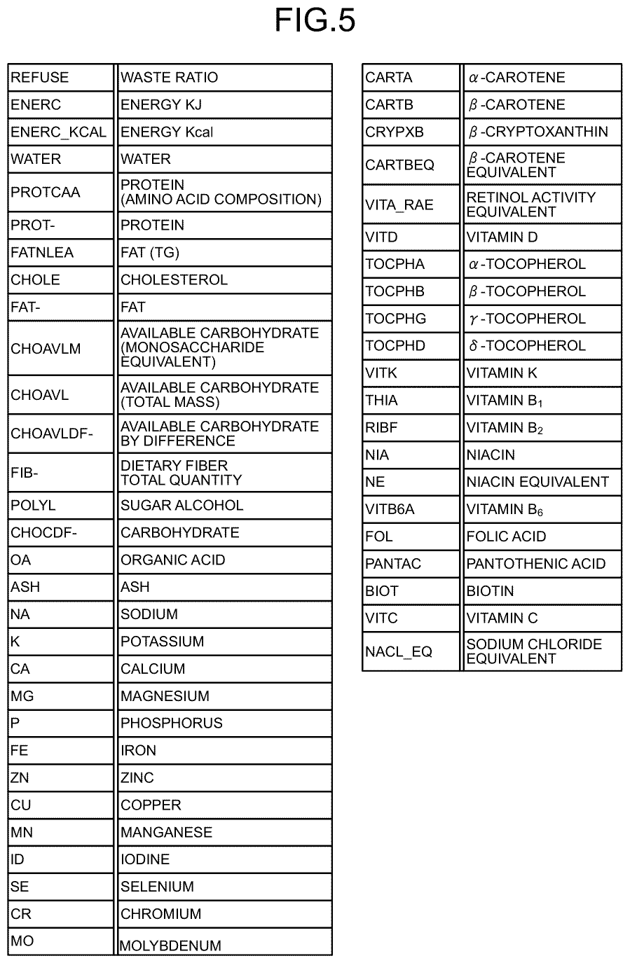

The nutrient component is, for example, an amount of each of 51 components illustrated in FIG. 5 contained in each of the 40 types of vegetables.

The physical characteristic is, for example, a color, sound, hardness, viscosity, elasticity, a shape, a smell, a taste, a weight, a material, and the like of the object.

The biological characteristic is, for example, a breed, genetic information, allergen information, and the like of the object.

The sociocultural characteristic is, for example, a price, a logotype, a mark, a brand, presence/absence of religious support, and the like of the object.

The other proper information is, for example, a manufacturing method, a production method, a manufacturer, a producer, a production time, a raw material, a production region, and the like of the object.

The objective information 106b about food may be oral sensation, a taste, a flavor, nutritional elements (protein, saccharides, fat, minerals, vitamins, and dietary fiber), texture, external appearance, swallowability, a functional component, a place of production, a producer, a production time, a price, and the like.

The objective information 106b about clothes may be a material, a design, a size, a folk costume, a fashion aesthetic, texture (feeling), a washing (handling) method, a function (UV cut and the like), persistence, a target (gender, age/age in months), a brand and a use (daily, sports, outdoor, formal, and the like) and the like. The objective information 106b about a house may be a structure, location, sunshine, a peripheral environment, the number of years after construction, a stand-alone house, collective housing, an occupied area, room arrangement, a style (a Japanese style, a Western style, and the like), a brand, a price, and the like. The objective information 106b about furniture may be a structure, a material, a color, texture, a brand, a price, and the like. The objective information 106b about a household electrical appliance may be classification (a refrigerator, a washing machine, and the like), a design, a function, a brand, a price, and the like. The objective information 106b about a car may be a design, classification (HV, EV, PHV, FCV, and the like), a use (for riding, agriculture, transportation, and the like), a displacement, a brand, a price, and the like.

The attribute information 106c is information about an attribute of a person. The person is, for example, the respondent who has answered to Q1 and Q2 in the questionnaire. The attribute information is, for example, at least one selected from the group consisting of gender, an age, a place of residence, an economic situation, a health situation, household members, a marital status, presence/absence of a child, a school carrier, a knowledge level, a religion and an attitude, a belief, genetic information, disease information, a purchase history, a use situation of SNS, a job, nationality, a hometown, migration history information, a hobby, a homepage browse and communication history, tax payment information, vital information (invasive, noninvasive), amino index information (registered trademark), an income, and the like.

The food consciousness information 106d is information about food consciousness of a person. The person is, for example, the respondent who has answered to Q1 and Q2 in the questionnaire. The food consciousness is, for example, a result obtained when the respondent answers to the following seven questionnaire items about the food consciousness with “Yes (applied)” or “No (not applied)”.
(Item 1) I am particular about selecting food items and cooking.
(Item 2) I use pesticide-free and organic agricultural products by choice.
(Item 3) I purchase a topical cooked product or food even if it is a little expensive.
(Item 4) I'm interested in eating and tasty restaurants.
(Item 5) I have purchased a perishable product via the Internet.
(Item 6) I want to eat more vegetables for nutrient balance.
(Item 7) I willingly collect information about a healthy meal.

The control unit 102 is a CPU and the like that centrally control the preference estimation apparatus 100. The control unit 102 includes an internal memory for storing a control program such as an OS, a computer program specifying various processing procedures and the like, required data, and the like, and performs various kinds of information processing based on these stored computer programs.

The control unit 102 conceptually includes, for example, (1) a model generating unit 102a as a model generating unit that generates, using preference information as information representing a preference of a person for an object, a preference space model as a model that includes a plurality of points each representing the object and a plurality of points each representing the person in a three-dimensional space and represents that the preference of the person for the object is higher as a distance between the point representing the object and the point representing the person is shorter, (2) a correlation calculating unit 102b as a correlation calculating unit that calculates a correlation between the point representing the object in the preference space model and objective information as objective information about the object, (3) a group generating unit 102c, (4) an object estimating unit 102d as an object estimating unit that estimates, using the preference information about a preference estimation person as a person whose preference is estimated, an object for which the preference estimation person has a high preference, based on the preference space model, (5) a person estimating unit 102e as a person estimating unit that estimates, using the objective information about a preference estimation object as an object as a target for estimating a person who prefers the object, a person who prefers the preference estimation object based on the correlation and the preference space model, and (6) an attribute/food consciousness presenting unit 102f as an attribute/food consciousness presenting unit that presents at least one of attribute information as information about an attribute of a person belonging to the specified group and food consciousness information as information about food consciousness of the person belonging to the specified group.

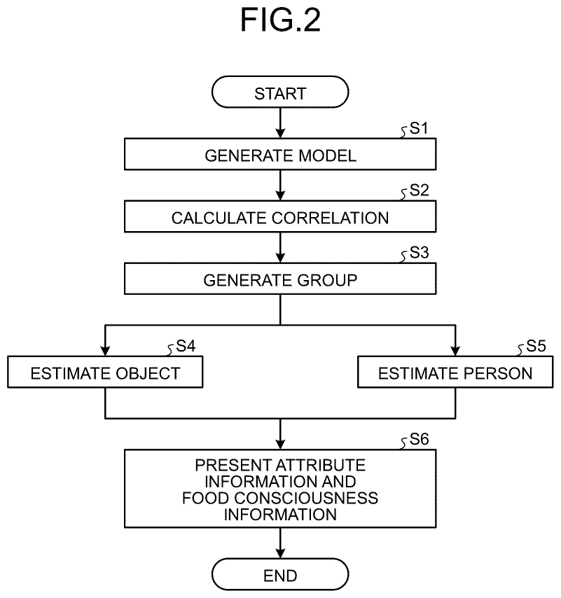

The model generating unit 102a generates a preference space model using the preference information 106a (Step S1 in FIG. 2).

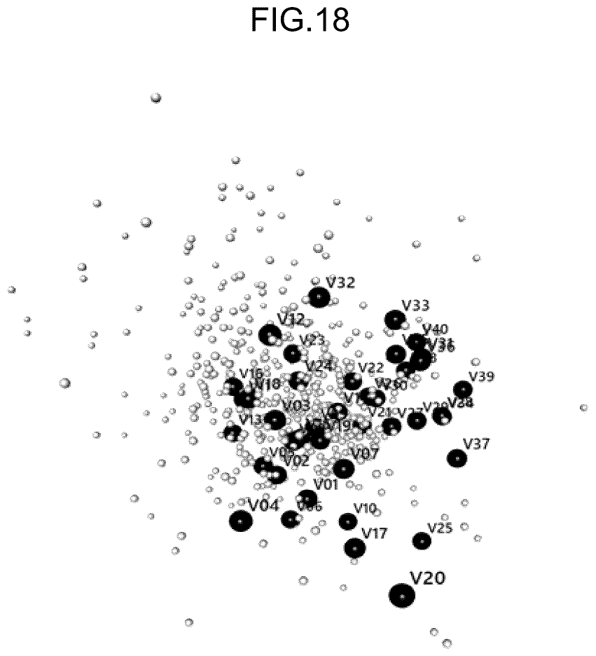

As illustrated in FIG. 18, the preference space model is a model including a plurality of points each representing the object (black circles in FIG. 18) and a plurality of points each representing the person (white circles in FIG. 18) in a three-dimensional space.

In the preference space model, as a distance between the point representing the object (black circle in FIG. 18) and the point representing the person (white circle in FIG. 18) is shorter, the preference of the person for the object is higher.

The preference space model can be generated by a known method using the preference information 106a. Examples of the known method include Landscape Segmentation Analyses (LSA, registered trademark) as one of a preference mapping method that has been proposed as an application of a multivariate analysis method.

Details about generation of the preference space model by the model generating unit 102a are described in the following [Step S1: Generation of preference space model] in [2. Specific example of processing].

The correlation calculating unit 102b calculates a correlation between the point representing the object in the preference space model and the objective information 106b (Step S2 in FIG. 2).

Details about calculation of the correlation by the correlation calculating unit 102b are described in the following [Step S2: Calculation of correlation] in [2. Specific example of processing].

The group generating unit 102c divides people who have answered to the questionnaire into a plurality of groups, based on the preference space model (Step S3 in FIG. 2).

Details about grouping performed by the group generating unit 102c are described in the following [Step S3: Generation of groups and examination of characteristics] in [2. Specific example of processing].

The object estimating unit 102d estimates, using the preference information 106a about the preference estimation person as a person whose preference is estimated, an object for which the preference estimation person has a high preference, based on the preference space model (Step S4 in FIG. 2).

Specifically, it is assumed that the points each representing the person are classified into the groups in the preference space model. In this case, the object estimating unit 102d specifies a group having the highest correlation with the preference of the preference estimation person from the groups using the preference information 106a about the preference estimation person. The object estimating unit 102d then estimates an object for which the specified group has a high preference as the object for which the preference estimation person has a high preference.

The object estimating unit 102d also estimates a new object as the object for which the preference estimation person has a high preference based on objective information about the object.

Details about estimation of the object by the object estimating unit 102d are described in the following [Step S4: Estimation of object] in [2. Specific example of processing].

The person estimating unit 102e estimates a person who prefers the preference estimation object based on the correlation and the preference space model using the objective information 106b about the preference estimation object as an object as a target for estimating a person who prefers the object (Step S5 in FIG. 2).

Specifically, it is assumed that the points each representing the person are classified into the groups in the preference space model, and space coordinates of a centroid of each of the groups is obtained. In this case, the person estimating unit 102e obtains space coordinates of the point representing the preference estimation object in the preference space model based on the correlation using the objective information 106b about the preference estimation object. Subsequently, the person estimating unit 102e specifies a group with a centroid having the shortest distance to the obtained space coordinates from the groups. The person estimating unit 102e then estimates a person belonging to the specified group as a person who prefers the preference estimation object.

Details about estimation of the person by the person estimating unit 102e are described in the following [Step S5: Estimation of person] in [2. Specific example of processing].

The attribute/food consciousness presenting unit 102f presents at least one of the attribute information 106c about the person belonging to the group specified by the object estimating unit 102d or the person estimating unit 102e, and the food consciousness information 106d about the person belonging to the group specified by the object estimating unit 102d or the person estimating unit 102e (Step S6 in FIG. 2).

Details about estimation of the object by the attribute/food consciousness presenting unit 102f are described in the following [Step S6: Presentation of attribute information and food consciousness information] in [2. Specific example of processing].

The control unit 102 may further include a preference information predicting unit 102g (not illustrated) as a preference information predicting unit that predicts, using the preference information about a preference estimation person as a person whose preference is estimated corresponding to each of some multiple types of objects, the preference information about the preference estimation person corresponding to each of the multiple types of residual objects based on a machine learning model that predicts the preference information corresponding to each of the multiple types of residual objects other than some of the multiple types of objects from the preference information as information representing a preference of a person for an object corresponding to each of some multiple types of objects among multiple types of predetermined objects, the machine learning model being generated based on a supervised learning method using the preference information corresponding to each of the multiple types of predetermined objects. The supervised learning method may correspond to classification. Specifically, the supervised learning method may correspond to a method of decision tree. More specifically, the supervised learning method may use a method of gradient boosting. Even more specifically, the supervised learning method may be a Light Gradient Boosting Machine (LightGBM). Details about prediction of the preference information by the preference information predicting unit 102g are described in the following [Step S1: Generation of preference space model] in [2. Specific example of processing].

The control unit 102 may further include (1) an object selecting unit 102h (not illustrated) as an object selecting unit that selects some multiple types of objects from multiple types of predetermined objects, and (2) a model generating unit 102i (not illustrated) as a model generating unit that generates, based on the supervised learning method, a machine learning model that predicts the preference information corresponding to each of the multiple types of residual objects other than selected objects from the preference information about each of the objects selected at the object selection step using the preference information as information representing a preference of a person for an object corresponding to each of the multiple types of predetermined objects. The model generating unit 102i may use the attribute information 106c (for example, gender and an age) when generating the machine learning model. Details about selection of the object by the object selecting unit 102h and details about generation of the machine learning model by the model generating unit 102i are described in the following [Step S1: Generation of preference space model] in [2. Specific example of processing].

The control unit 102 may further include an MAE calculating unit 102j (not illustrated) as an MAE calculating unit that calculates a mean absolute error with respect to a prediction result obtained by the machine learning model generated at the model generating step assuming that the preference information corresponding to each of the multiple types of residual objects is a correct answer. When the control unit 102 includes the MAE calculating unit 102j, the object selecting unit 102h may select the multiple types of objects in descending order of the mean absolute error. Details about calculation of the mean absolute error by the MAE calculating unit 102j are described in the following [Step S1: Generation of preference space model] in [2. Specific example of processing].

The control unit 102 may further include a correlation coefficient calculating unit 102k (not illustrated) as a correlation coefficient calculating unit that calculates a correlation coefficient of the preference information for each pair of objects using the preference information corresponding to each of the multiple types of predetermined objects. When the control unit 102 includes the correlation coefficient calculating unit 102k, the object selecting unit 102h may select the multiple types of objects in ascending order of the correlation coefficient. Details about calculation of the correlation coefficient by the correlation coefficient calculating unit 102k are described in the following [Step S1: Generation of preference space model] in [2. Specific example of processing].

When the control unit 102 includes the MAE calculating unit 102j and the correlation coefficient calculating unit 102k, the object selecting unit 102h may select multiple types of objects by selecting the multiple types of objects in descending order of the mean absolute error, selecting a pair of objects in descending order of the correlation coefficient from the selected objects, and excluding an object having a smaller mean absolute error from the selected pair of objects.

The control unit 102 may further include a sensitivity map creating unit 102m (not illustrated) as a sensitivity map creating unit that creates a sensitivity map for the preference space model generated by using the preference information as information representing a preference of a person for an object, the preference space model including the points each representing the objects and the points each representing the person in the three-dimensional space and representing that the preference of the person for the object is higher as a distance between the point representing the object and the point representing the person is shorter. When the control unit 102 includes the sensitivity map creating unit 102m, the object selecting unit 102h may select multiple types of objects by selecting an object to be excluded based on the sensitivity map, selecting multiple types of objects in descending order of the mean absolute error from the multiple types of predetermined objects from which the selected object has been excluded, selecting a pair of objects in descending order of the correlation coefficient from the selected objects, and excluding an object having a smaller mean absolute error from the selected pair of objects. Details about creation of the sensitivity map by the sensitivity map creating unit 102m are described in the following [Step S1: Generation of preference space model] in [2. Specific example of processing].

### 2. Specific Example of Processing

This section describes a specific example of processing according to the present embodiment.

In this specific example, the 40 types of vegetables (V01 to V40) illustrated in FIG. 3 are used as subjects of the questionnaire for generating a model. In this specific example, 23 types of sense characteristics (A01 to A23) illustrated in FIG. 4 are used as objective information for calculating the correlation. In this specific example, 51 types of nutrient components illustrated in FIG. 5 are used as another piece of the objective information for calculating the correlation.

### Step S1: Generation of Preference Space Model

This section describes generation of the preference space model by the model generating unit 102a in detail. The processing described in this section corresponds to Step S1 in FIG. 2.

First, a Web questionnaire illustrated in FIG. 6 was performed for 500 respondents. Specifically, the 500 respondents answered to a question of Q1 “How much do you like? Please answer while imagining a representative dish.” for each of the 40 types of vegetables. The respondents answered how much they liked the vegetable with nine ranks from 1 point (dislike the best) to 9 points (like the best) as illustrated in FIG. 7.

The 500 respondents also answered to a question of Q2 “Please select all appropriate characteristics for this vegetable from the following word list (multiple selection is allowed).” for each of the 40 types of vegetables. The “following word list” indicates the 23 types of sense characteristics illustrated in FIG. 4.

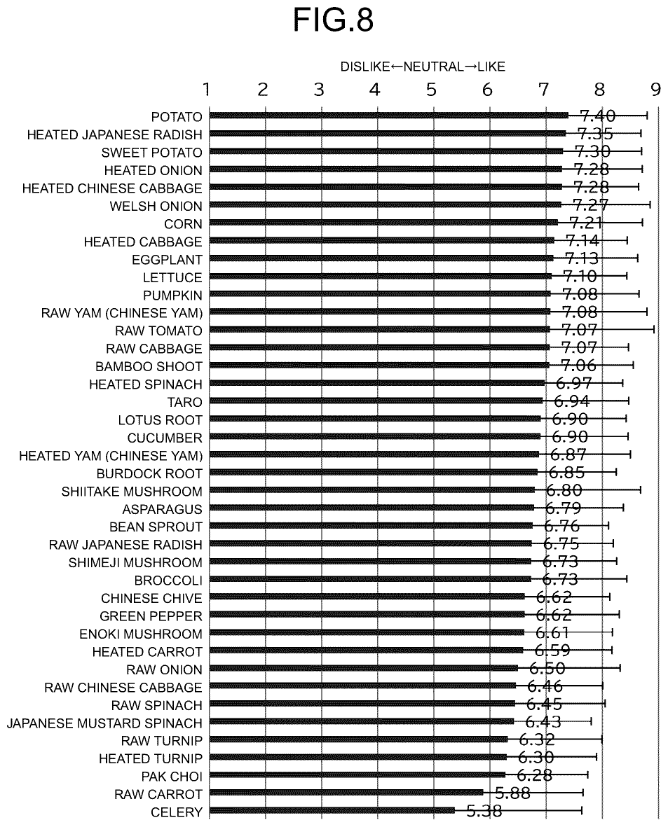

A graph in FIG. 8 indicates average values (preference average values) of answers of “1 point (dislike the best) to 9 points (like the best)” to Q1 for each of the 40 types of vegetables. In FIG. 8, bars indicate a standard deviation (sd), that is, variation of preferences. As illustrated in FIG. 8, a potato and a heated Japanese radish are preferred, and on the other hand, celery and a raw carrot are not preferred.

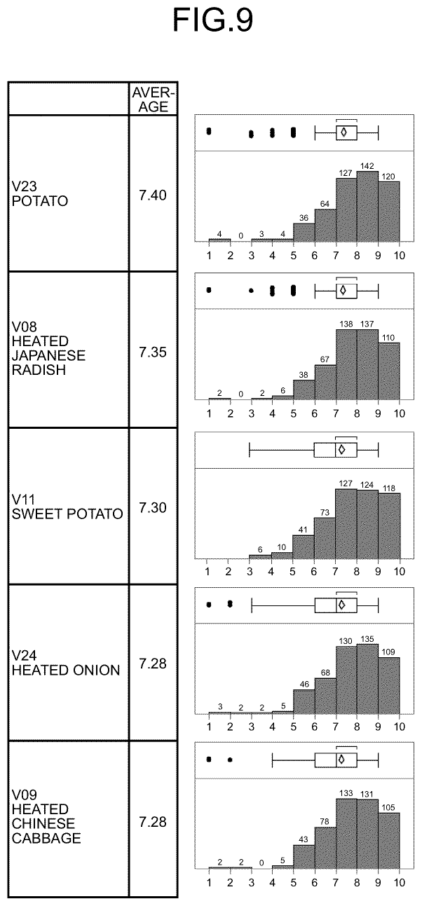

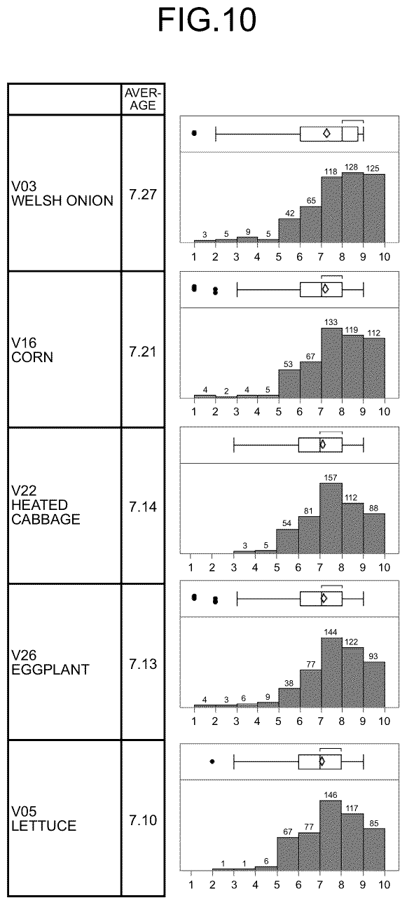

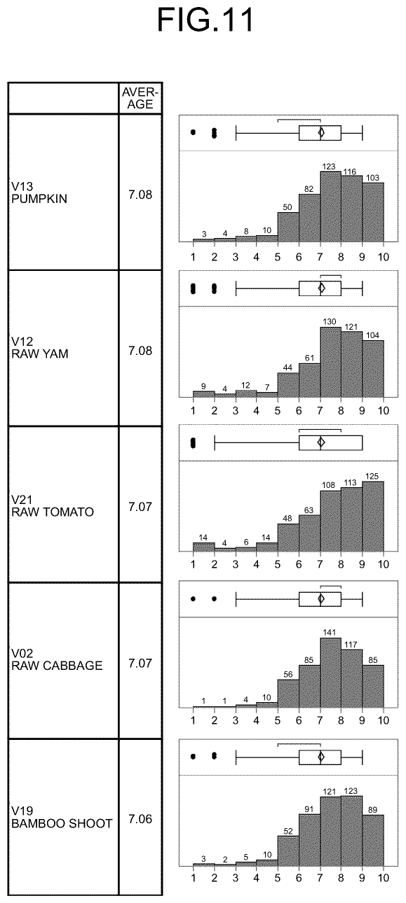

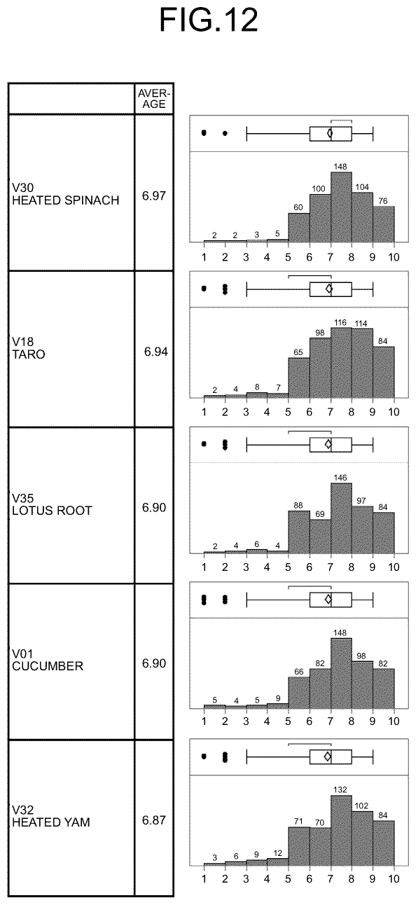

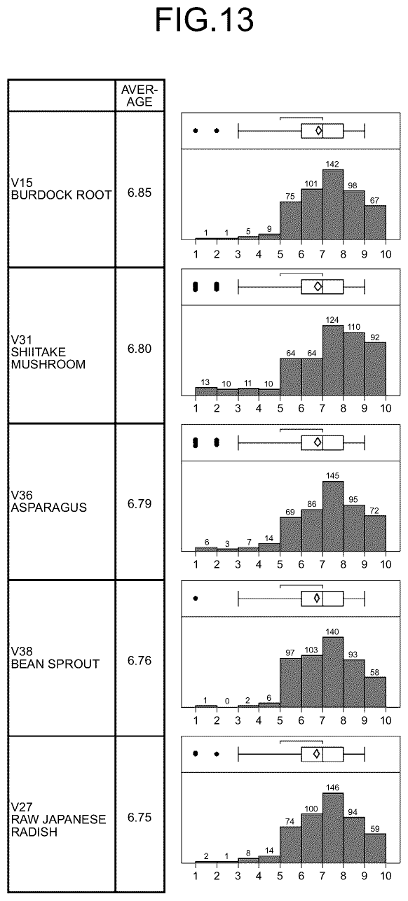

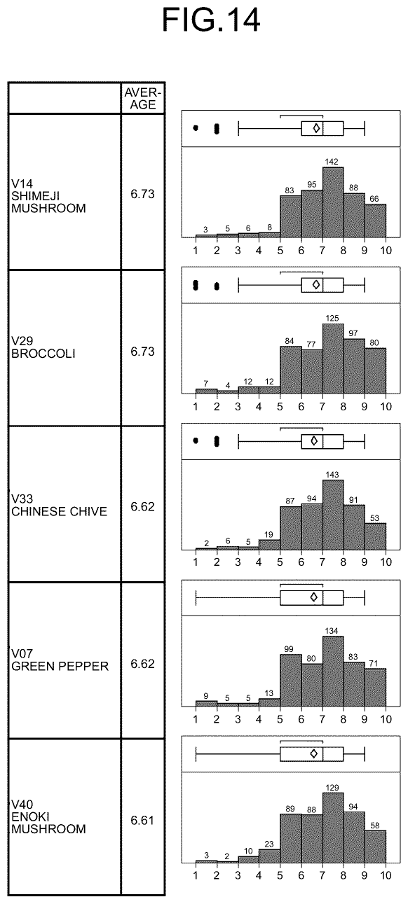

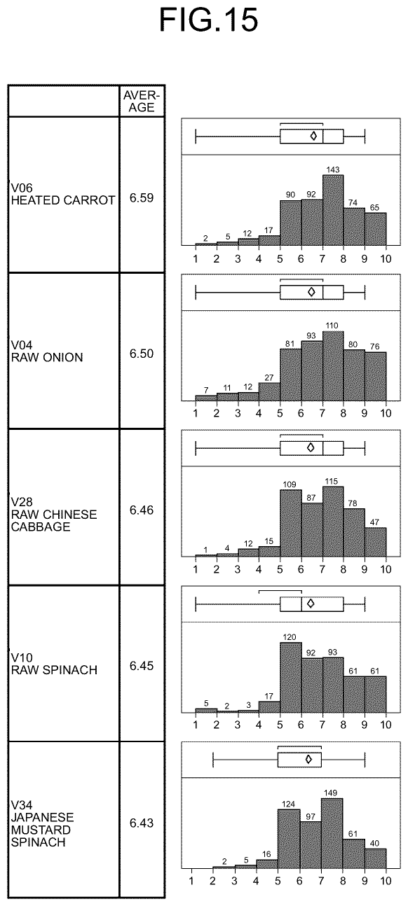

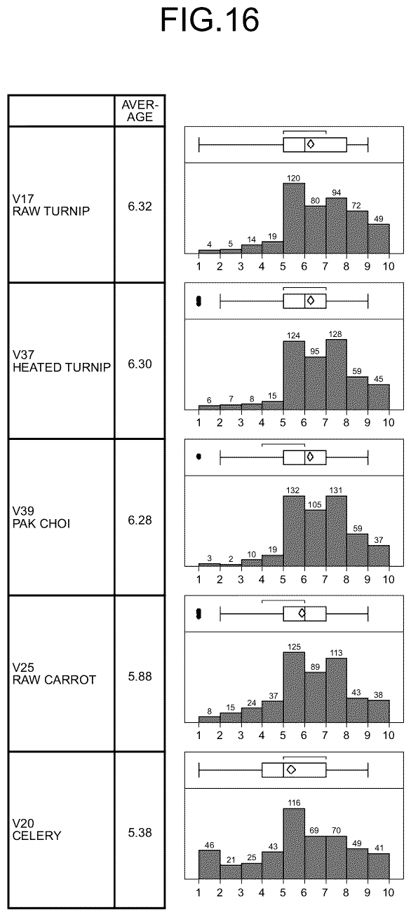

Graphs in FIG. 9 to FIG. 16 separately indicate distribution (preference distribution) of answers of “1 point (dislike the best) to 9 points (like the best)” to Q1 for the 40 types of vegetables. Values for the vegetables illustrated in FIG. 9 to FIG. 12 were generally high, and no bimodality was found. About the vegetables illustrated in FIG. 13 to FIG. 16, a green pepper scored 6.6 points on average and celery scored 5.4 points on average, so that it was suggested that the preference for the vegetable is increased when being eaten as a dish rather than being eaten as only the vegetable.

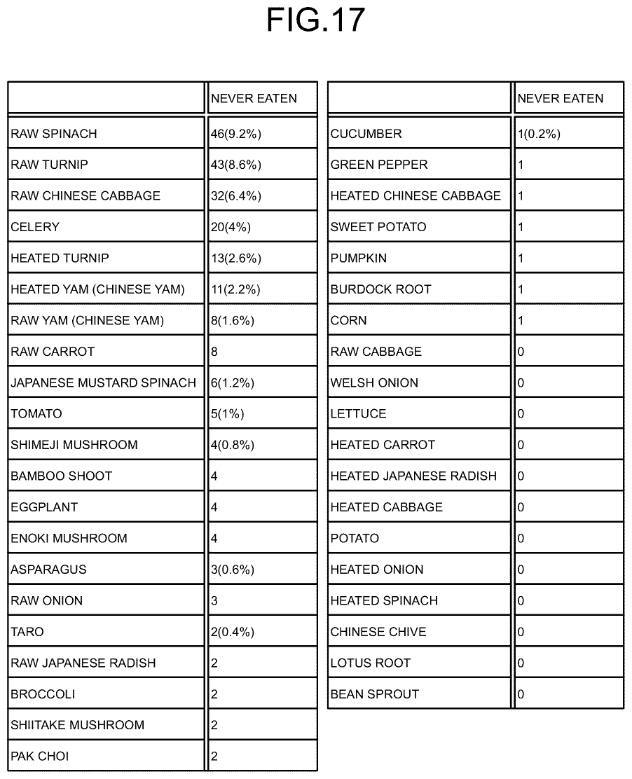

A graph in FIG. 17 indicates a result of answers of “0 points (I do not know because I have never eaten it)” to Q1 about the 40 types of vegetables. As illustrated in FIG. 17, a ratio of people who had never eaten raw spinach, a raw turnip, and a raw Chinese cabbage was 5%, which was high.

The model generating unit 102a generated a preference space model (LSA map) using LSA while using the answer results for Q1. In this example, as software of LSA, IFPrograms (registered trademark) 9 Professional Ver. 9.0.4.9, which is software manufactured by Institute for Perception in USA, was used. In generating the preference space model, 231 answers (1.2%) of “0 points (I don't know because I have never eaten it)” were treated as missing values.

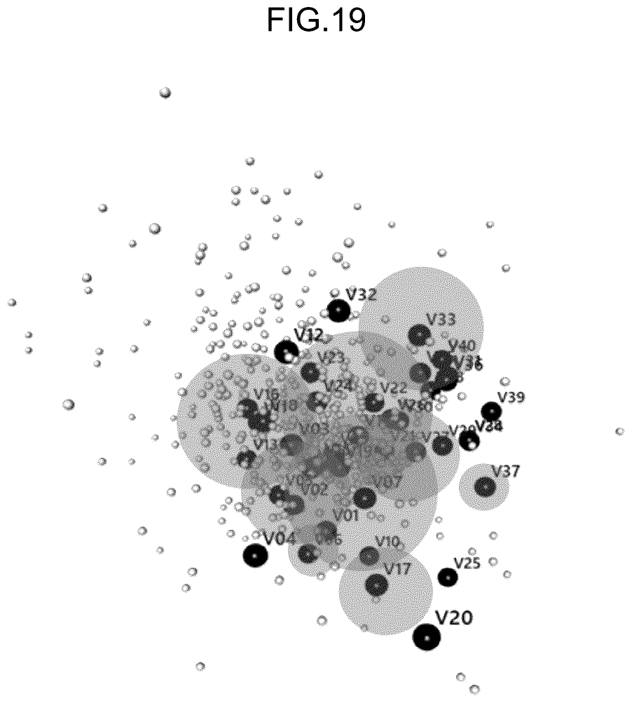

FIG. 18 and FIG. 19 illustrate the generated preference space model. In FIG. 18 and FIG. 19, a white circle represents a person, and a black circle represents a vegetable. In FIG. 18 and FIG. 19, as a distance between the white circle and the black circle is shorter, the preference of the person represented by the white circle for the vegetable represented by the black circle is higher.

As represented by the preference space model in FIG. 18 and FIG. 19, the white circles and the black circles were concentrated to the center, so that there was a tendency such that many people answered “like” for all vegetables. As illustrated in FIG. 19, a result was obtained such that spheres are large for a shimeji mushroom (V14), a burdock root (V15), a green pepper (V07), a taro (V18), a raw Japanese radish (V27), Chinese chives (V33), a bamboo shoot (V19), a raw turnip (V17), a heated onion (V24), a heated turnip (V37), and a heated carrot (V06), that is, errors in the answers were large for these vegetable (sd=0.03 or more).

The questionnaire about the 40 types of vegetables can be simplified to be a questionnaire about 10 types or 20 types of vegetables, for example, by the first to the second steps as follows.

At the first step, a group of vegetables the points of which are close to each other in the LSA map (preference space model) for the 40 types of vegetables is generated (cluster analysis). In other words, the vegetables are classified based on preferences of the people for the vegetables.

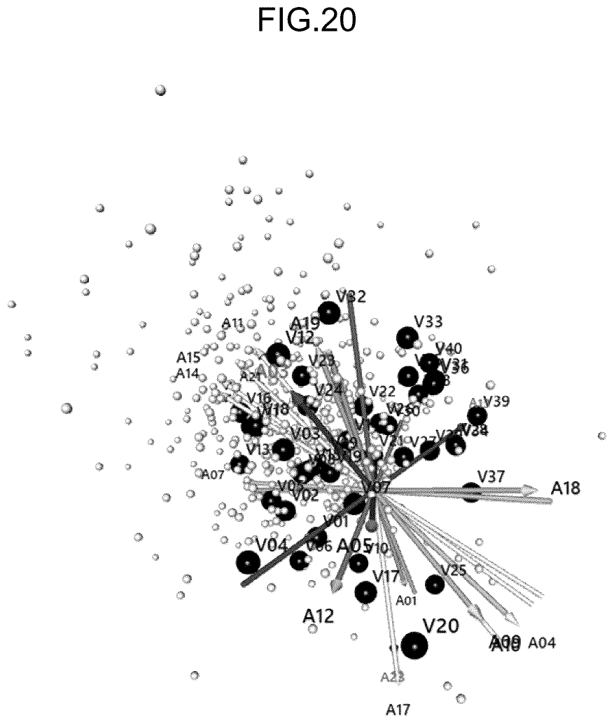

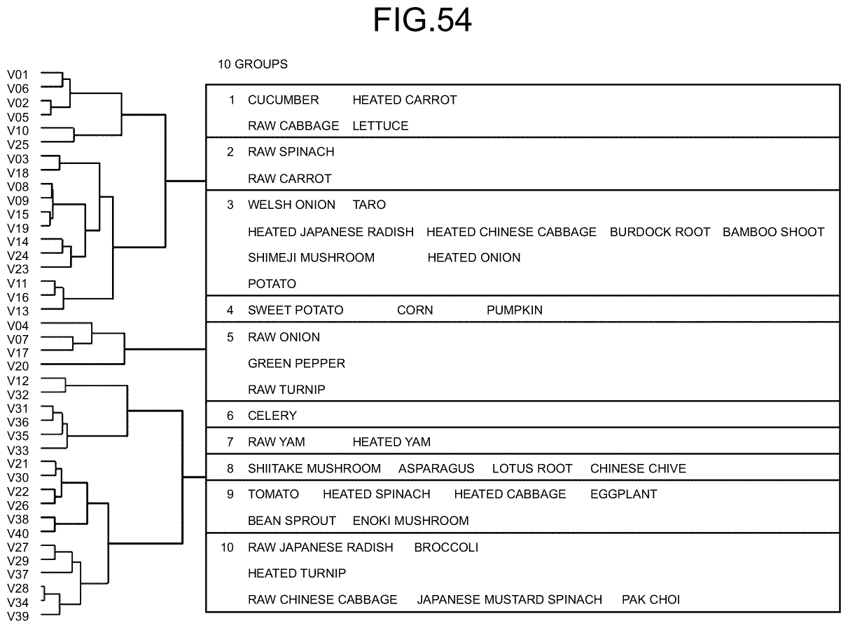

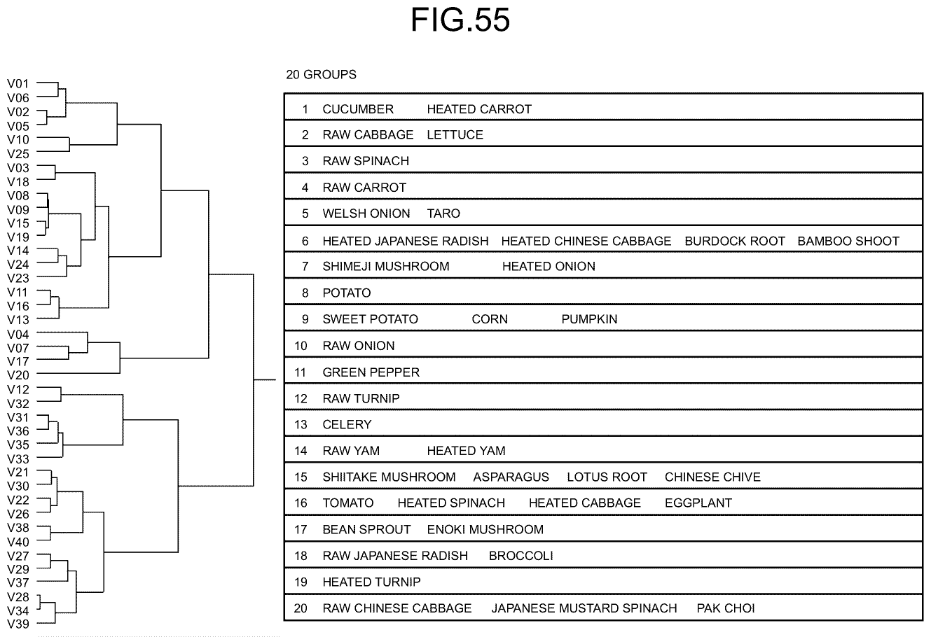

This result is illustrated in FIG. 54 and FIG. 55. Tree diagrams in FIG. 54 and FIG. 55 indicate similarity of the vegetables. Tables in FIG. 54 and FIG. 55 indicate a result of grouping the vegetables based on the tree diagrams. In this way, 10 groups indicated by the table of FIG. 54 and 20 groups indicated by the table of FIG. 55 are generated.

At the second step, while referring to the tree diagrams, one type of representative vegetable is selected from each of the generated 10 groups, and one type of representative vegetable is selected from each of the generated 20 groups. That is, the 10 types of vegetables and the 20 types of vegetables are selected.

The method of simplifying the questionnaire has been described above at the first step and the second step. Subsequently, comparison with the LSA map for the 40 types of vegetables can be performed by performing the third step and the fourth step described below.

At the third step, the preferences of the 500 people are reanalyzed for the 10 types of vegetables or the 20 types of vegetables selected at the second step (LSA analysis). Due to this, an LSA map for the 10 types of vegetables or an LSA map for the 20 types of vegetables is generated.

At the fourth step, the LSA map for the 10 types of vegetables or the LSA map for the 20 types of vegetables generated at the third step is compared with the LSA map for the 40 types of vegetables (original map) from the following four viewpoints.
Applicability of a model
Correlation analysis
Type of Drivers of Liking (DOL)
LO classification

The questionnaire about the 40 types of vegetables can be simplified to be a questionnaire about a smaller number (for example, 5, 10, 20, or 30) of types of vegetables than the 40 types, for example, without changing a prediction result of the preference group with the preference space model using a method that uses a machine learning model. For example, with a machine learning model that predicts, based on an answer result of the questionnaire about 20 types of vegetables among the 40 types of vegetables, an answer result of the questionnaire about the 20 types of residual vegetables, by predicting an answer result of the questionnaire about the 20 types of residual vegetables, it is only necessary to obtain an answer result of the questionnaire about the 20 types of vegetables from the respondent without changing the prediction result of the preference group based on the preference space model.

The machine learning model may be obtained by performing the following [1: Selection process] and [2: Generation process], for example.
[1: Selection process] Select 20 types of vegetables among the 40 types of vegetables.
[2: Generation process] With a Light Gradient Boosting Machine (LightGBM), by using a result of about 6,000 answers to the questionnaire about the 40 types of vegetables collected in advance, generate the machine learning model that predicts, based on an answer result of the questionnaire about the 20 types of selected vegetables, an answer result of the questionnaire about the 20 types of residual vegetables.

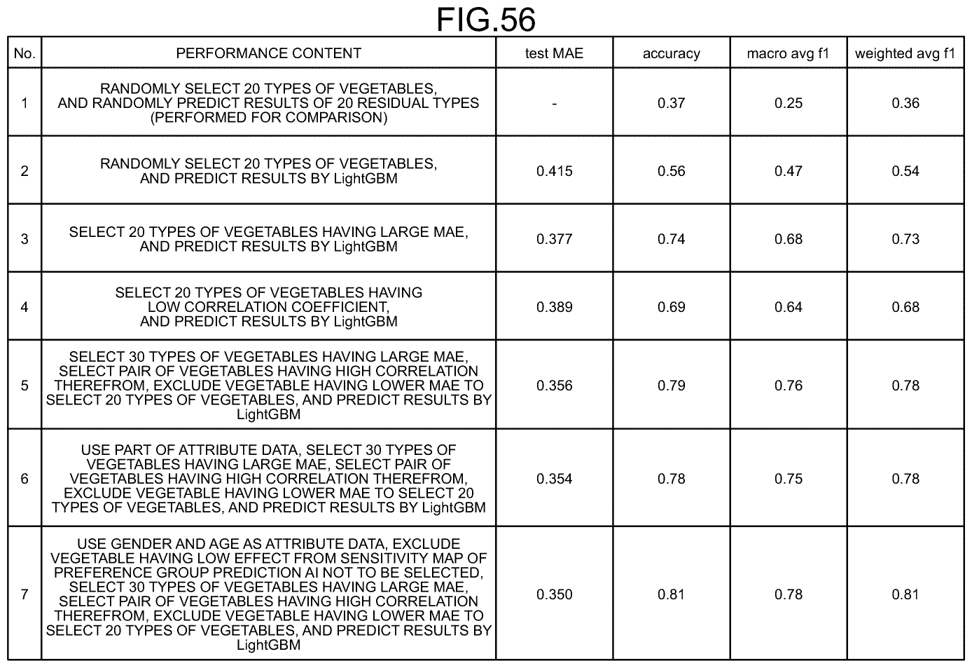

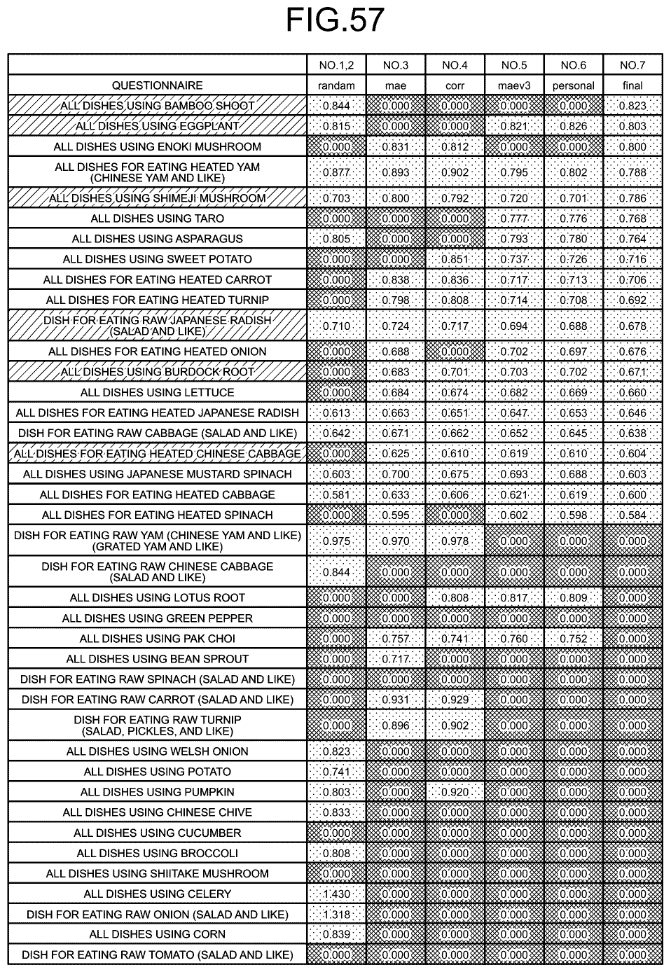

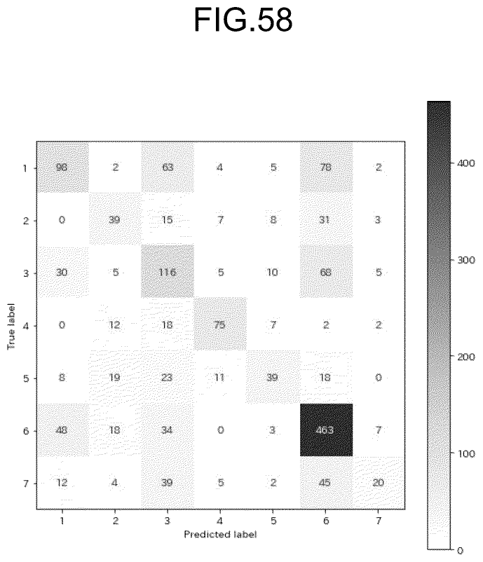

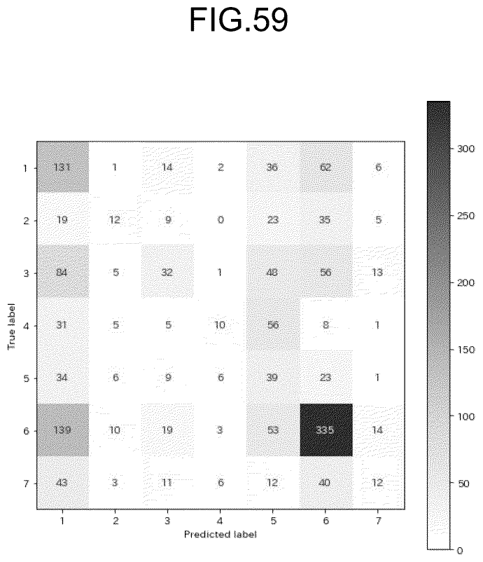

In [1: Selection process], the 20 types of vegetables may be randomly selected (selection method 1). Regarding accuracy of the prediction result of the preference group based on the preference space model, based on a prediction result obtained when all of the answer results of the questionnaire about the 40 types of vegetables were obtained from respondents, accuracy of the prediction result was 0.56 when the answer results of the questionnaire about the 20 types of vegetables among the answer results of the questionnaire about the 40 types of vegetables were predicted by the machine learning model generated by performing the selection method 1 (refer to a row of No. 2 in the table in FIG. 56). The selected 20 types of vegetables were vegetables for which values of “0.000” were indicated in a column of No. 2 in the table in FIG. 57. A confusion matrix visualizing distribution of differences between prediction and correct answers is illustrated in FIG. 58. For comparison, when 20 types of vegetables were randomly selected and answer results of the questionnaire about the 20 types of residual vegetables were randomly predicted, accuracy of the prediction result was 0.37 (refer to a row of No. 1 in the table in FIG. 56). The selected 20 types of vegetables were vegetables for which values of “0.000” were indicated in a column of No. 1 in the table in FIG. 57. A confusion matrix visualizing distribution of differences between prediction and correct answers is illustrated in FIG. 59.

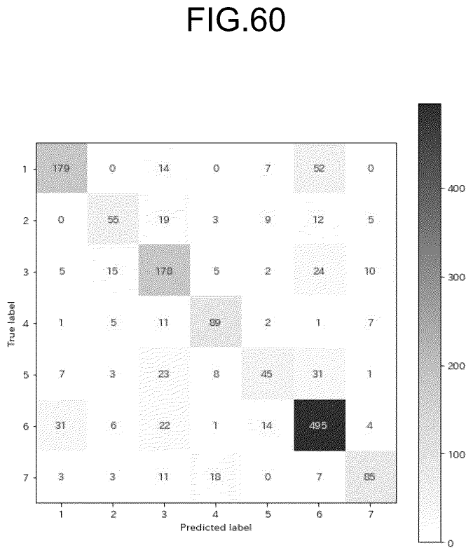

By calculating a mean absolute error (MAE) with respect to a prediction result based on the machine learning model generated in [2: Generation process] assuming that the answer result of the questionnaire about the 20 types of residual vegetables that are not selected in [1: Selection process) is a correct answer, 20 types of vegetables may be selected in descending order of the mean absolute error in (1: Selection process] (selection method 2). Regarding accuracy of the prediction result of the preference group based on the preference space model, based on a prediction result obtained when all of the answer results of the questionnaire about the 40 types of vegetables were obtained from the respondents, the accuracy of the prediction result was 0.74 when the answer results of the questionnaire about the 20 types of vegetables among the answer results of the questionnaire about the 40 types of vegetables were predicted by the machine learning model generated by performing the selection method 2 (refer to a row of No. 3 in the table in FIG. 56). The selected 20 types of vegetables were vegetables for which values of “0.000” were indicated in a column of No. 3 in the table in FIG. 57. A confusion matrix visualizing distribution of differences between prediction and correct answers is illustrated in FIG. 60. The accuracy was improved by selecting a vegetable for which a correct answer was hardly obtained.

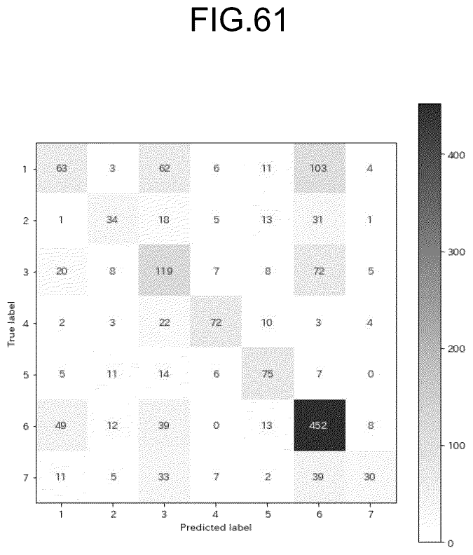

By calculating a correlation coefficient of the answer result for each pair of vegetables using the answer results of the questionnaire about the 40 types of vegetables, 20 types of vegetables may be selected in ascending order of the correlation coefficient in [1: Selection process] (selection method 3). Regarding accuracy of the prediction result of the preference group based on the preference space model, based on a prediction result obtained when all of the answer results of the questionnaire about the 40 types of vegetables were obtained from the respondents, the accuracy of the prediction result was 0.69 when the answer results of the questionnaire about the 20 types of vegetables among the answer results of the questionnaire about the 40 types of vegetables were predicted by the machine learning model generated by performing the selection method 3 (refer to a row of No. 4 in the table in FIG. 56). The selected 20 types of vegetables were vegetables for which values of “0.000” were indicated in a column of No. 4 in the table in FIG. 57. A confusion matrix visualizing distribution of differences between prediction and correct answers is illustrated in FIG. 61. The accuracy was improved not only by selecting a vegetable for which a correct answer was hardly obtained but also by selecting a vegetable having a low correlation coefficient.

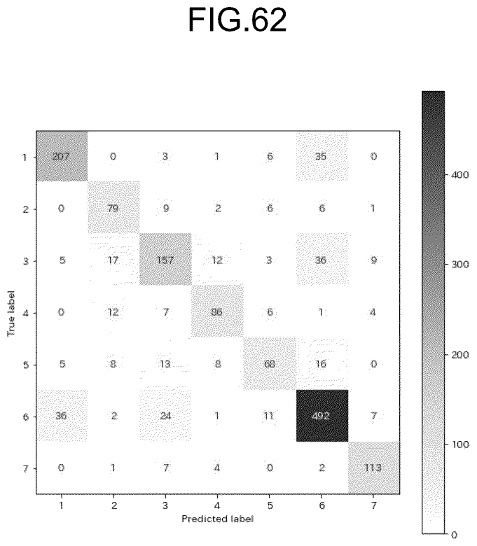

In [1: Selection process], 20 types of vegetables may be selected by performing three steps of selecting 30 types of vegetables in descending order of the mean absolute error, selecting a pair of vegetables in descending order of the correlation coefficient from the selected vegetables, and excluding a vegetable having a smaller mean absolute error from the selected pair of vegetables (selection method 4). Regarding the accuracy of the prediction result of the preference group based on the preference space model, based on a prediction result obtained when all of the answer results of the questionnaire about the 40 types of vegetables were obtained from the respondents, the accuracy of the prediction result was 0.79 when the answer results of the questionnaire about the 20 types of vegetables among the answer results of the questionnaire about the 40 types of vegetables were predicted by the machine learning model generated by performing the selection method 4 (refer to a row of No. 5 in the table in FIG. 56). The selected 20 types of vegetables were vegetables for which values of “0.000” were indicated in a column of No. 5 in the table in FIG. 57. A confusion matrix visualizing distribution of differences between prediction and correct answers is illustrated in FIG. 62. The accuracy was further improved by excluding a pair of vegetables having a high correlation from vegetables for which correct answers were hardly obtained.

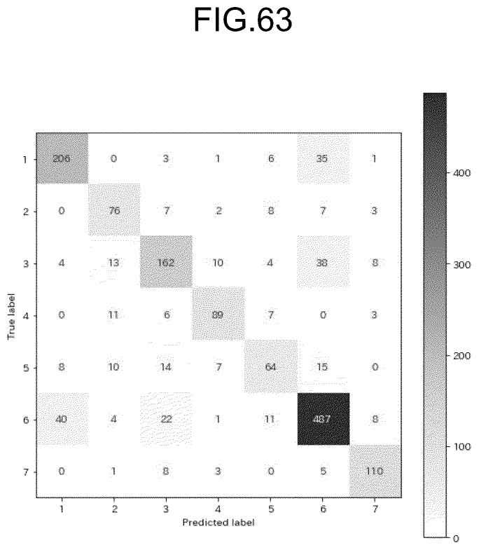

In [2: Generation process], the attribute information 106c may be used in generating the machine learning model. Regarding the accuracy of the prediction result of the preference group based on the preference space model, based on a prediction result obtained when all of the answer results of the questionnaire about the 40 types of vegetables were obtained from the respondents, the accuracy of the prediction result was 0.78 when the answer results of the questionnaire about the 20 types of vegetables among the answer results of the questionnaire about the 40 types of vegetables were predicted by the machine learning model generated by performing the selection method 4 using the attribute information 106c (refer to a row of No. 6 in the table in FIG. 56). The selected 20 types of vegetables were vegetables for which values of “0.000” were indicated in a column of No. 6 in the table in FIG. 57. A confusion matrix visualizing distribution of differences between prediction and correct answers is illustrated in FIG. 63. The accuracy was not changed even if the attribute data was used.

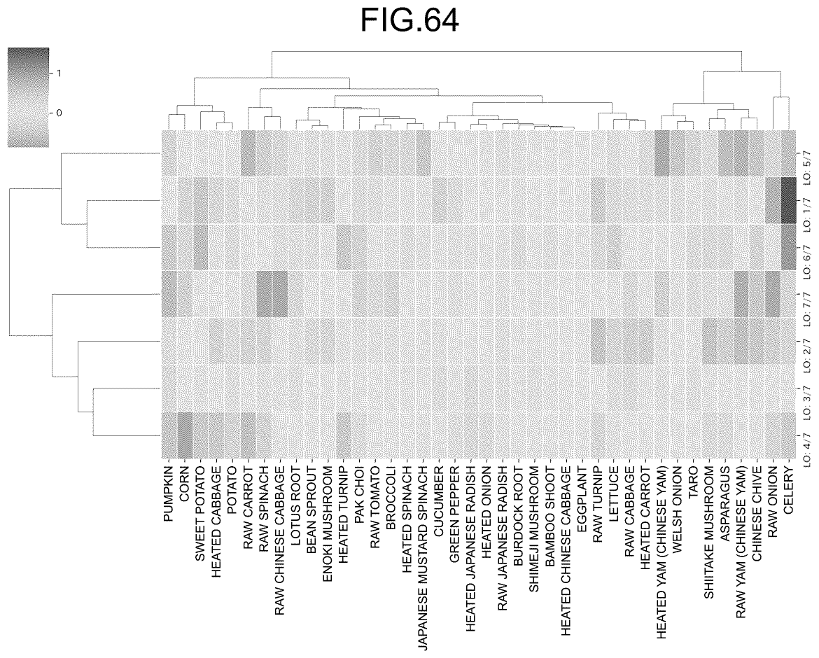

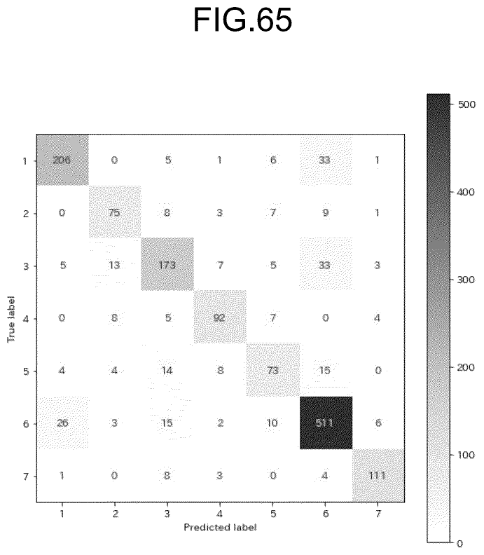

By creating a sensitivity map of the preference space model (refer to FIG. 64), in [1: Selection process], 20 types of vegetables may be selected by performing four steps of selecting a vegetable to be excluded from the 40 types of vegetables based on the sensitivity map, selecting 30 types of vegetables in descending order of the mean absolute error from the multiple types of vegetables from which the selected vegetable has been excluded, selecting a pair of vegetables in descending order of the correlation coefficient from the selected vegetables, and excluding a vegetable having a smaller mean absolute error from the selected pair of vegetables (selection method 5). Regarding the accuracy of the prediction result of the preference group based on the preference space model, based on a prediction result obtained when all of the answer results of the questionnaire about the 40 types of vegetables were obtained from the respondents, the accuracy of the prediction result was 0.81 when the answer results of the questionnaire about the 20 types of vegetables among the answer results of the questionnaire about the 40 types of vegetables were predicted by the machine learning model generated by performing the selection method 5 using gender and an age (refer to a row of No. 7 in the table in FIG. 56). The selected 20 types of vegetables were vegetables for which values of “0.000” were indicated in a column of No. 7 in the table in FIG. 57. The vegetables excluded from the 40 types of vegetables were six types of vegetables having low sensitivity in the sensitivity map (“all dishes using a bamboo shoot”, “all dishes using an eggplant”, “all dishes using a shimeji mushroom”, “a dish for eating a raw Japanese radish (a salad and the like)”, “all dishes using a burdock root”, and “all dishes for eating a heated Chinese cabbage”). A confusion matrix visualizing distribution of differences between prediction and correct answers is illustrated in FIG. 65. It can be considered that the accuracy is increased due to an effect of improving selection of the vegetables rather than influence of the attribute data.

The description about the method of simplifying the questionnaire using the machine learning model is ended.

### Step S2: Calculation of Correlation

This section describes calculation of the correlation by the correlation calculating unit 102b in detail. The processing described in this section corresponds to Step S2 in FIG. 2.

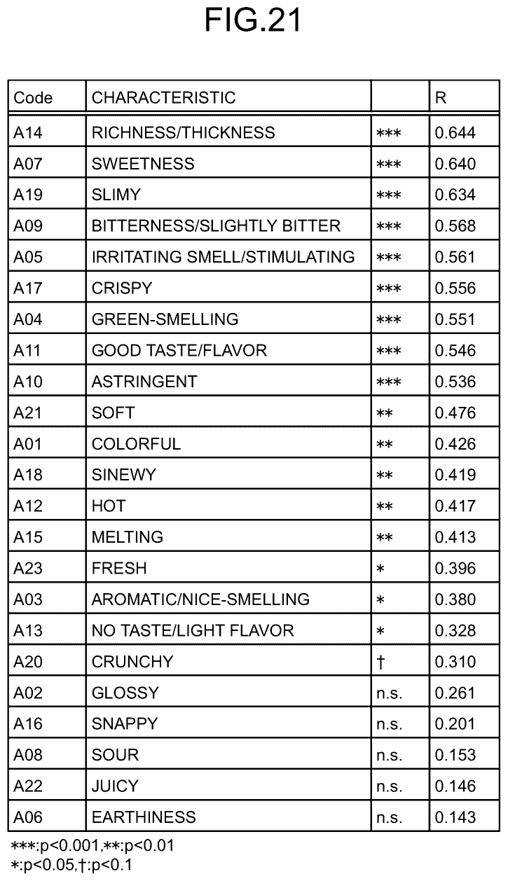

The correlation calculating unit 102b calculated a correlation between the vegetable and an answer result for Q2 (question about the 23 types of sense characteristics) in the questionnaire described at Step S1. Some of calculated correlations are indicated by arrows on the preference space model of FIG. 20. The correlation calculating unit 102b also calculated a correlation coefficient between the answer result for Q2 (question about the 23 types of sense characteristics) in the questionnaire described at Step S1 and space coordinates of the vegetable. FIG. 21 indicates calculated correlation coefficients.

As illustrated in FIG. 21, a value of the correlation coefficient (R) became large for richness/thickness (A14), sweetness (A07), slimy (A19), bitterness/slightly bitter (A09), irritating smell/stimulating (A05), crispy (A17), green-smelling (A04), good taste/flavor (A11), and astringent (A10), so that it was suggested that these sense characteristics had high relevance to vegetable preferences.

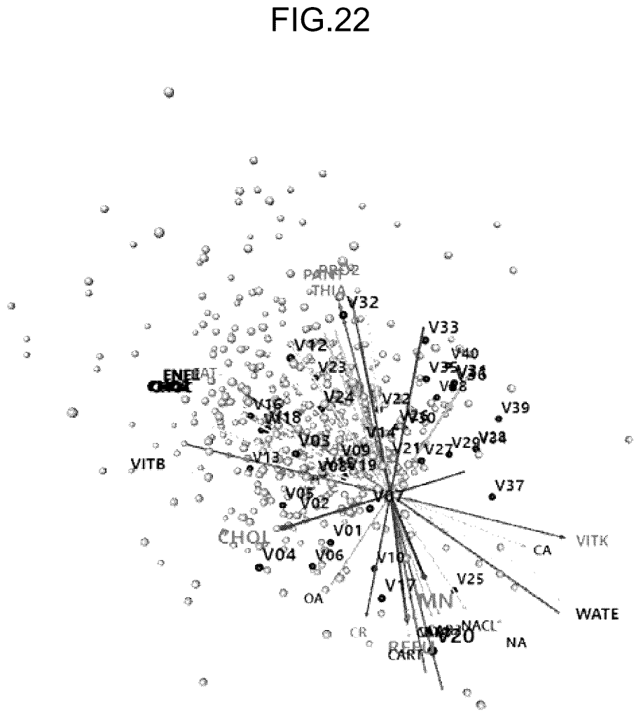

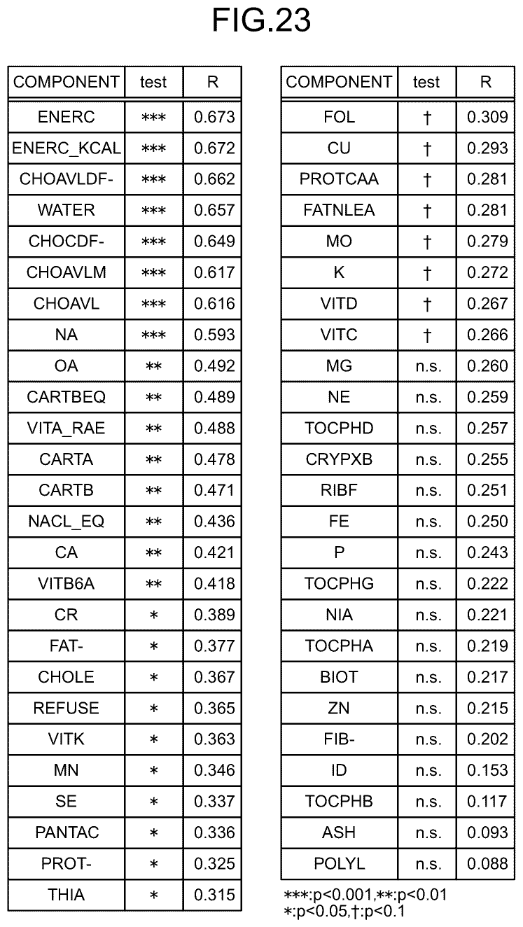

The correlation calculating unit 102b also calculated correlations between the vegetables and the 51 types of nutrient components described at the beginning of this section [2. Specific example of processing]. Some of the calculated correlations are indicated by arrows on the preference space model of FIG. 22. The correlation calculating unit 102b also calculated correlation coefficients between the 51 types of nutrient components and space coordinates of the vegetables. FIG. 23 indicates the calculated correlation coefficients.

As illustrated in FIG. 23, a value of the correlation coefficient (R) became large for energy (ENERC), carbohydrates (CHO), water (WATER), sodium (NA), organic acid (OA), carotenes (CART), retinol (VITA_RAE), a sodium chloride equivalent (NACL_EQ), calcium (CA), vitamin B6, chromium (CR), fat (FAT−), cholesterol (CHOLE), a waste ratio (REFUSE), vitamin K (VITK), manganese (MN), selenium (SE), and the like, so that it was suggested that these nutrient components had high relevance to vegetable preferences.

By using the answer result for Q2 (question about the 23 types of sense characteristics) in the questionnaire described at Step S1, sense characteristics of the vegetables felt by consumers were examined based on a Check-All-That-Apply method (CATA method). The CATA method is a method of checking an evaluation term estimated to represent a characteristic of a sample among a plurality of evaluation terms to clarify the characteristic of the sample based on a frequency with which each evaluation term is checked.

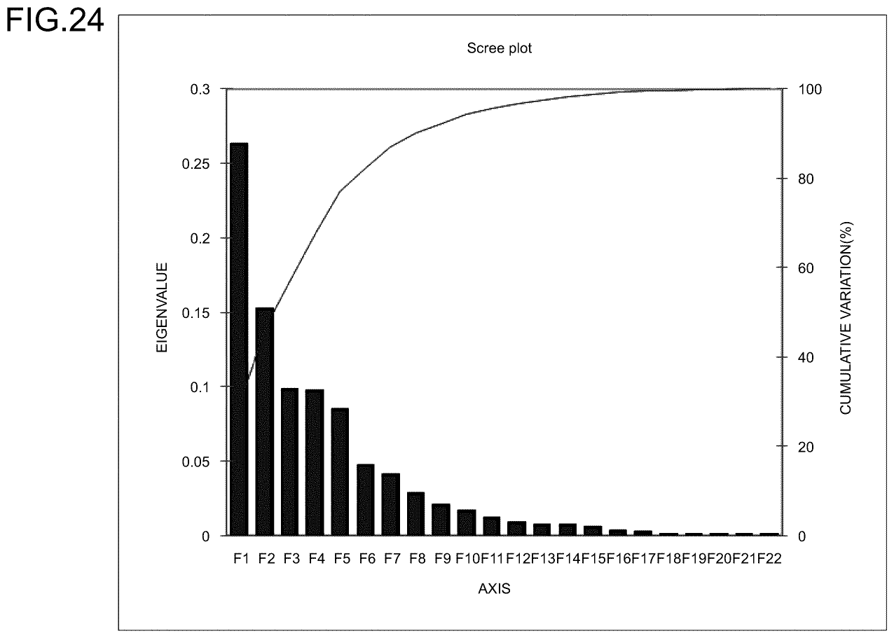

As a result, a contribution ratio of each component illustrated in FIG. 24 was obtained. As illustrated in FIG. 24, a contribution ratio of a first component (F1) was 29.1%, a contribution ratio of a second component (F2) was 16.8%, a contribution ratio of a third component (F3) was 10.9%, a contribution ratio of a fourth component (F4) was 10.8%, and a contribution ratio of a fifth component (F5) was 9.4%, and it was found that 60% of the whole information can be visualized with F1 to F3.

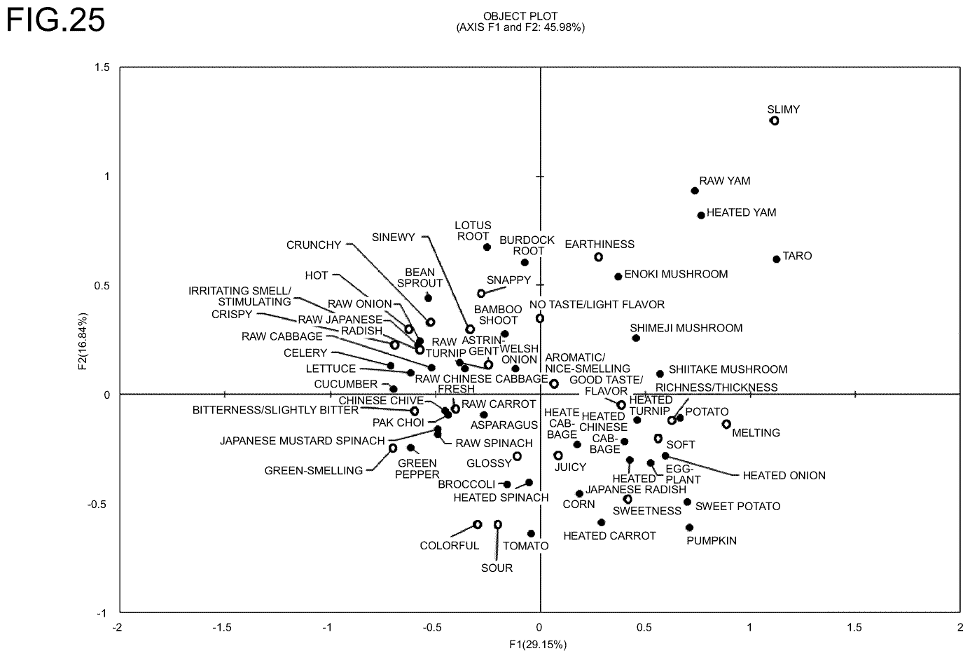

Thus, a graph illustrated in FIG. 25 is generated by plotting results obtained by the CATA method on a graph with a horizontal axis indicating F1 and a vertical axis indicating F2. In FIG. 25, white circles represent the sense characteristics, and black circles represent the vegetables. In FIG. 25, as a distance between the white circle and the black circle is shorter, the sense characteristic represented by the white circle for the vegetable represented by the black circle is higher. In FIG. 25, when a distance between the sense characteristics represented by the white circles is short, it indicates that “terms are assumed to have similar meanings”. On the other hand, when a distance between the sense characteristics represented by the white circles is long, it indicates that “terms are assumed to have different meanings”.

As illustrated in FIG. 25, on a F1×F2 plane, it was found that “crispy, irritating smell/stimulating, hot” and “melting, soft” made a pair, and “slimy” and “sour” made a pair.

### Step S3: Generation of Groups and Examination of Characteristics

This section describes generation of the groups by the group generating unit 102c in detail. This section also describes examination of the characteristics of the generated groups in detail. The processing described in this section corresponds to Step S3 in FIG. 2.

### (1) Method of Grouping

First, the following describes a method of grouping.

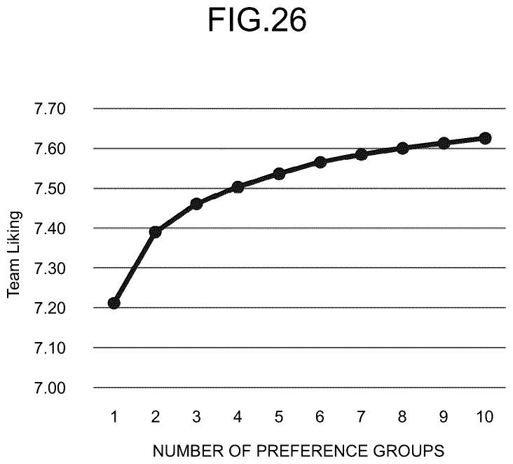

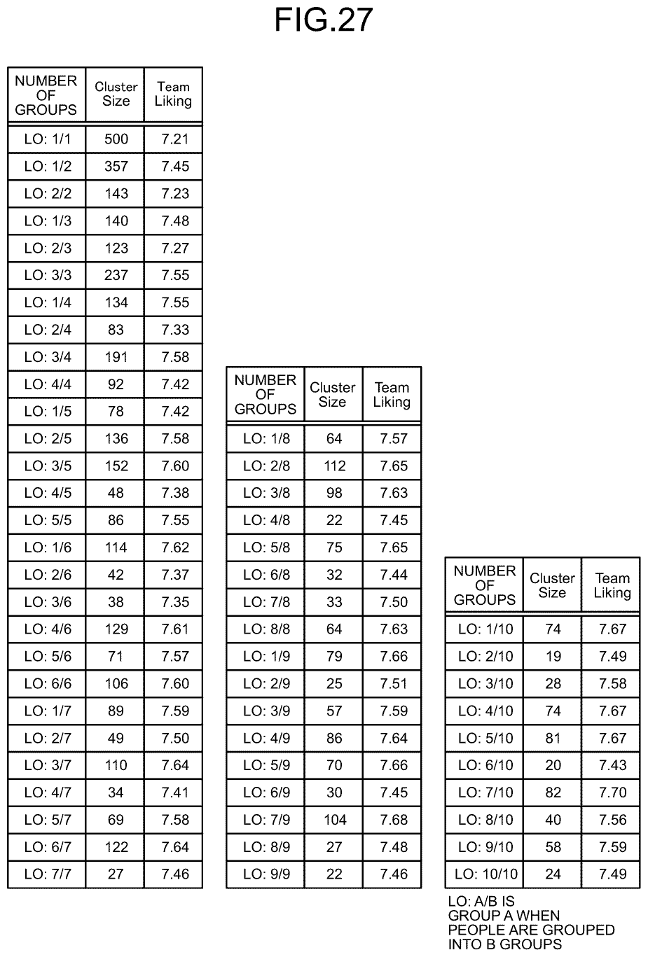

The 500 white circles (representing 500 people) in the preference space model generated at Step S1 were divided into 1 to 10 groups. FIG. 26 indicates a relation between the number of divisions (the number of preference groups) and Team Liking (estimated preference average marks of the groups). FIG. 27 indicates the number of people (cluster size) and Team Liking for each of the groups when being divided. In FIG. 27, “LO: A/B” means a group A when the people are grouped (divided) into B groups.

An ideal number of divisions (number of groups) is a number satisfying three conditions including (i) the number of people (cluster size) is equal to or more than 25 in all of the groups, (ii) a value of Team Liking is as large as possible, and (iii) the value of Team Liking reaches a plateau. Referring to FIG. 26 and FIG. 27, the three conditions are satisfied when the number of divisions (number of groups) is “7”.

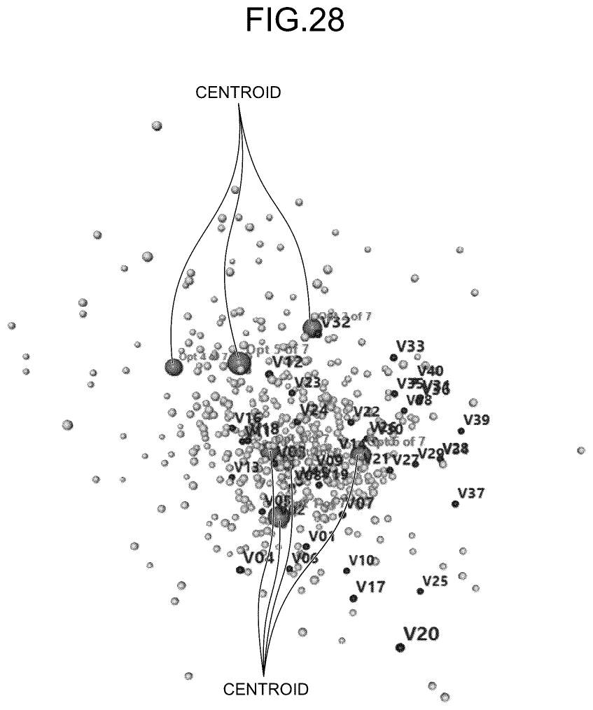

Thus, the group generating unit 102c divided the white circles (representing the people) in the preference space model generated at Step S1 into seven groups. For each of the seven groups, the group generating unit 102c obtained a centroid as illustrated in FIG. 28.

### (2) Characteristics of Each Group

Next, characteristics of each group was examined. Specifically, preferences, attribute information (demographics), and food consciousness were examined for each group.

### (2-1) Preferences of Each Group

The preferences of each group were examined.

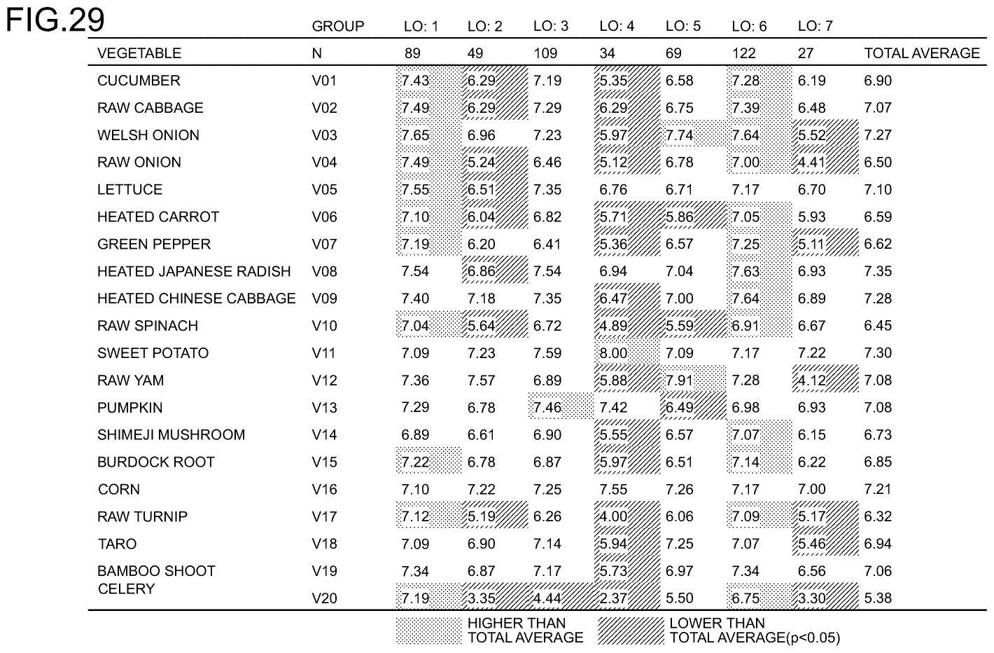

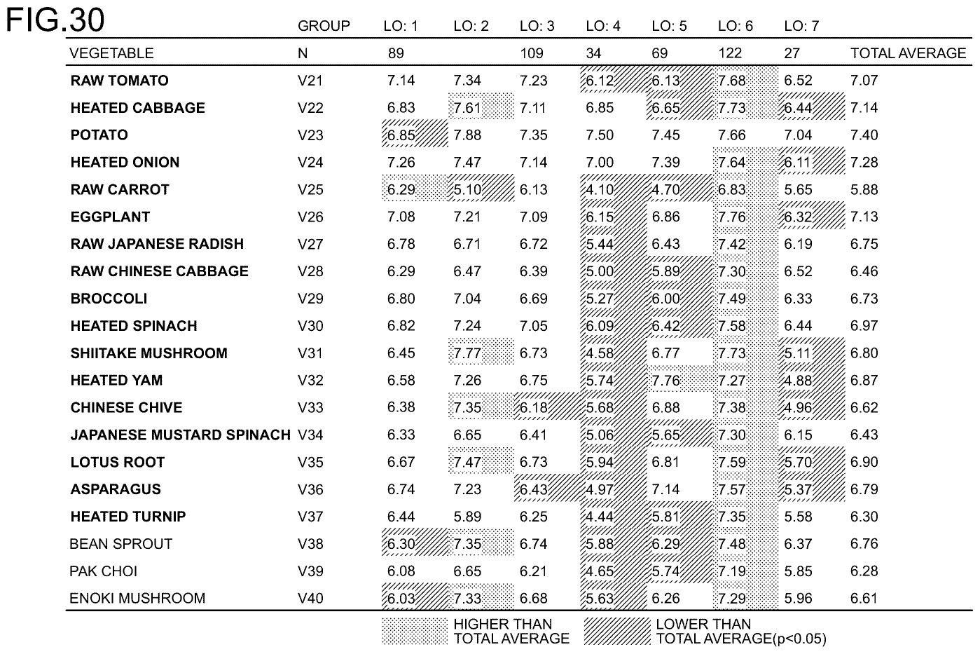

First, preferences of the respective groups (LO1 to LO7) for 40 types of vegetables were examined. LO is an abbreviation of Liking Optima, and represents a preference group. FIG. 29 and FIG. 30 indicate average values of answers of each of the seven groups for the question Q1 “How much do you like? Please answer while imagining a representative dish.” in the questionnaire at Step S1, and total average values. FIG. 29 indicates average values of answers for vegetables of V01 to V20, and FIG. 30 indicates average values of answers for vegetables of V21 to V40.

The people were considered to “greatly like” the vegetable when the average value of the answers was equal to or more than 7.5, “slightly dislike” the vegetable when the average value of the answers was equal to or less than 5.5, and “dislike” the vegetable when the average value of the answers was less than 4.5. The people were considered to “relatively like” the vegetable when the average value of the answers was larger than the total average, and the average value of the answers in this case was indicated by dot-like hatching in FIG. 29 and FIG. 30. On the other hand, the people were considered to “not greatly like” the vegetable when the average value of the answers is lower than the total average, and the average value of the answers in this case was indicated by hatching with oblique lines in FIG. 29 and FIG. 30.

The preferences of the respective groups read from FIG. 29 and FIG. 30 are as follows.
LO6 (122 people) . . . Like any vegetable (don't dislike any vegetable).
LO4 (34 people) . . . Greatly like a sweet potato. Not greatly like most of the other vegetables. Dislike celery, a raw turnip, a raw carrot, and a heated turnip.
LO1 (89 people) . . . Greatly like a Welsh onion, lettuce, a raw cabbage, a heated Japanese radish, a raw cabbage, and a raw onion. Relatively like a raw carrot as compared with the other groups, but not greatly like a potato, bean sprouts, and an enoki mushroom.
LO2 (49 people) . . . Greatly like a potato, a shiitake mushroom, a heated cabbage, and a lotus root. Greatly dislike celery (3.4 points). Relatively like Chinese chives, bean sprouts, and an enoki mushroom as compared with the other groups, but slightly dislike a raw onion, a raw turnip, and a raw carrot.
LO3 (109 people) . . . Greatly like a pumpkin. Dislike celery (4.4 points).
LO5 (69 people) . . . Greatly like a yam (raw, heated) and a Welsh onion. Slightly dislike celery and a raw carrot.
LO7 (27 people) . . . Slightly dislike a taro, asparagus, a raw turnip, a shiitake mushroom, a green pepper, Chinese chives, and a heated yam. Dislike a raw onion, a raw yam, and celery.

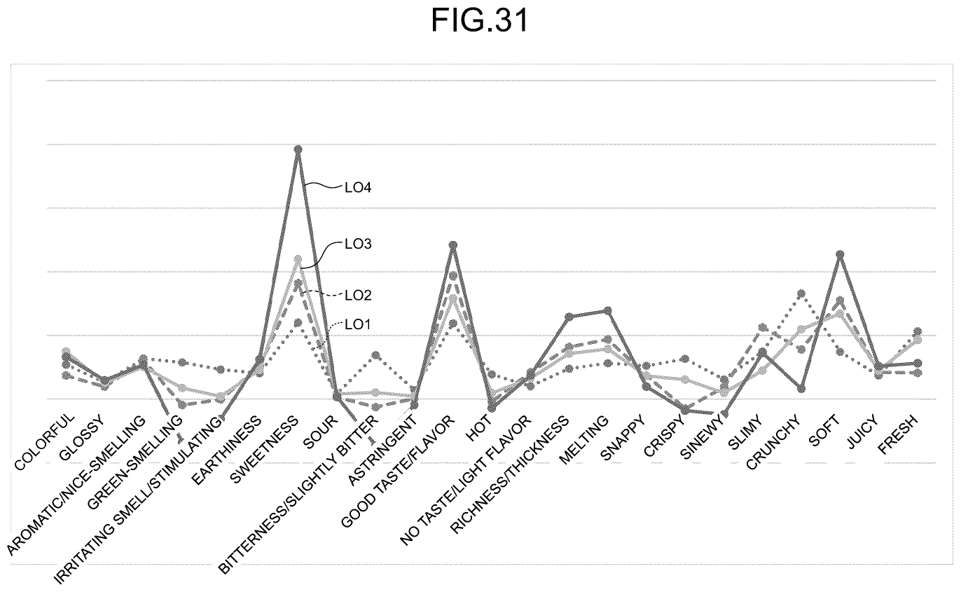

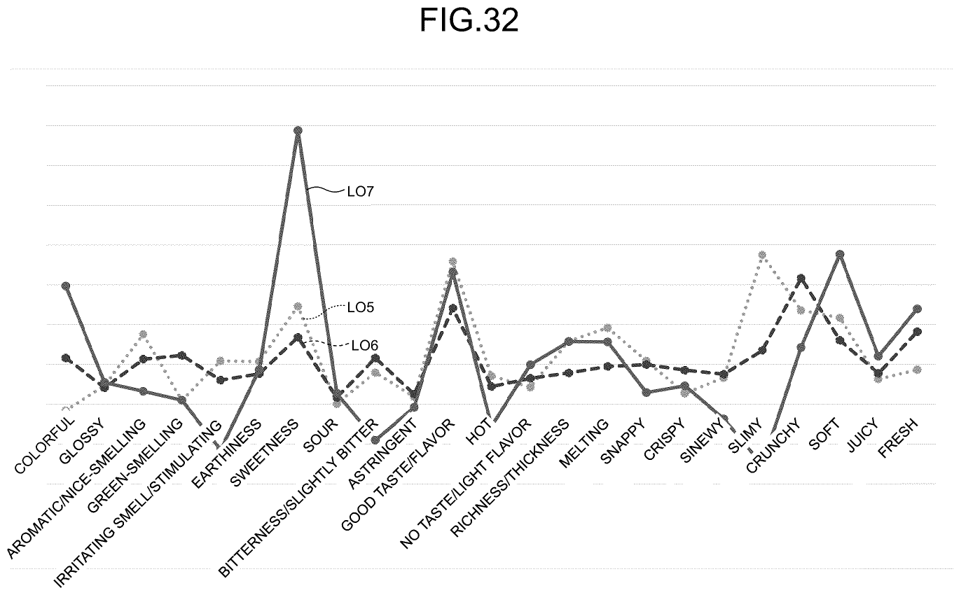

The preferences of the respective groups (LO1 to LO7) for the 23 types of sense characteristics were examined. In other words, a sense characteristic desired by each group for a preferred vegetable was examined. FIG. 31 and FIG. 32 indicate appearance frequencies of sense characteristics answered for preferred vegetables among the sense characteristics answered by the seven groups in response to the question of Q2 “Please select all appropriate characteristics for this vegetable from the following word list (multiple selection is allowed).” in the questionnaire at Step S2.

In FIG. 31 and FIG. 32, a horizontal axis indicates the sense characteristic, and a vertical axis indicates the frequency with which the people answers that they feel the sense characteristic for the preferred vegetable. FIG. 31 indicates results for the groups of LO1 to LO4, and FIG. 32 indicates results for the groups of LO5 to LO7.

The preferences of the respective groups read from FIG. 31 and FIG. 32 are as follows.
LO4 . . . Like sweetness, a good taste, richness, melting, and softness. On the other hand, dislike green-smelling, bitterness, crispness, sinewy, and crunchiness.
LO5 . . . Like an aroma, an irritating smell, and stickiness. On the other hand, not care about colorfulness.
LO7 . . . Like colorfulness, sweetness, and softness. On the other hand, dislike earthiness and crunchiness.
LO1 . . . Like an irritating smell, bitterness, crispness, crunchiness, and freshness.

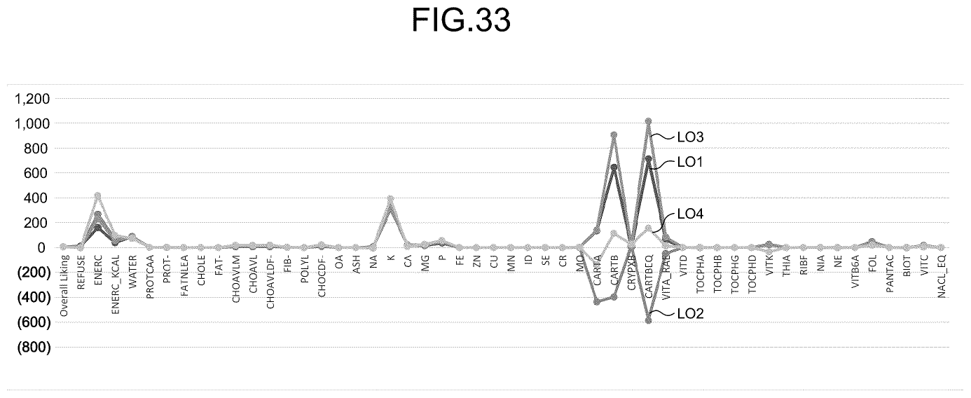

The preferences of the respective groups (LO1 to LO7) for the 51 types of nutrient components were examined. In other words, nutrient components related to vegetables preferred by the respective groups were examined. FIG. 33 to FIG. 36 indicate nutrient components of the vegetables preferred by the respective groups.

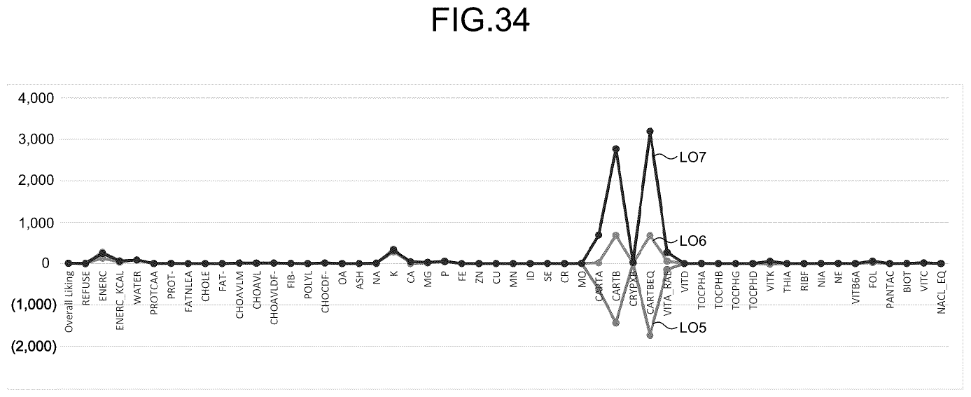

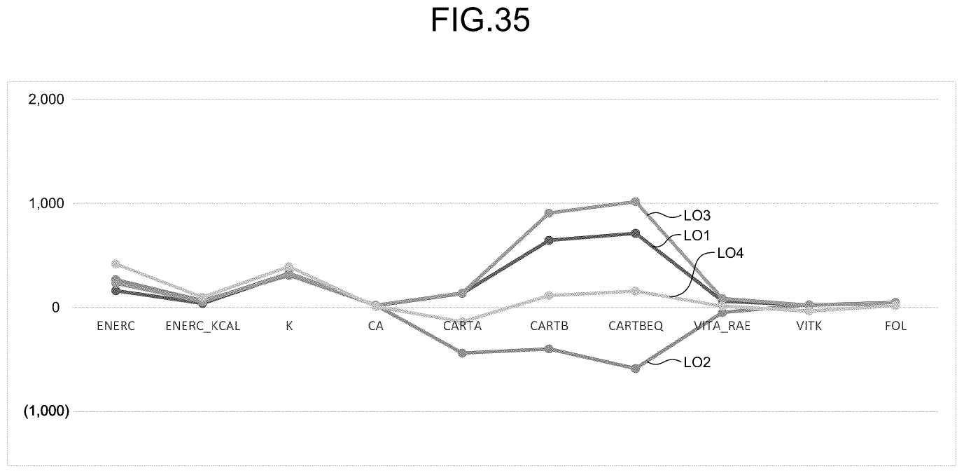

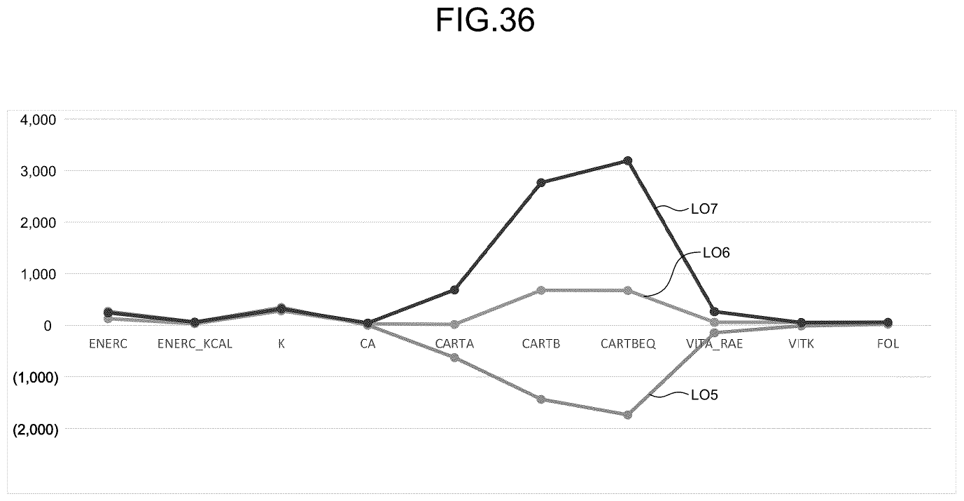

FIG. 33 and FIG. 34 indicate all 51 types of nutrient components. FIG. 35 and FIG. 36 indicate important components selected from the nutrient components. In FIG. 33 to FIG. 36, a horizontal axis indicates the nutrient component, and a vertical axis indicates an amount of the nutrient component contained in the preferred vegetable. FIG. 33 and FIG. 35 indicate results for the groups of LO1 to LO4, and FIG. 34 and FIG. 36 indicate results for the groups of LO5 to LO7.

The results read from FIG. 33 and FIG. 34 are as follows.
Top 10 items of components varied in virtual vegetables (with a maximum preference) assumed for the groups were, in standard deviation (SD), CARTBEQ (β-carotene equivalent), CARTB (β-carotene), CARTA (α-carotene), ENRC (energy KJ), VITA_RAE (retinol activity equivalent), K (potassium), VITK (vitamin K), Ca (calcium), ENRC_KCAL (energy Kcal), and FOL (folic acid).
Top 10 items of components varied in virtual vegetables (with a maximum preference) assumed for the groups were, in coefficients of variation (CV), NA (sodium), CARTBEQ (β-carotene equivalent), VITA_RAE (retinol activity equivalent), CARTB (β-carotene), CHOLE (cholesterol), VITK (vitamin K), REFUSE (waste ratio), CR (creatine), SE (selenium), and TOCPHB (β-tocopherol).
There were no difference among the groups for a FIB (dietary fiber total quantity), OA (organic acid), and VITC (vitamin C) as components of interest.

The results read from FIG. 35 and FIG. 36 are as follows.
It was suggested that, when virtual vegetables with the maximum preference are assumed for the groups, contents of energy, potassium, and carotenes may be greatly different among the groups regarding food components contained in the virtual vegetables (LO: O/7 in the drawings).

### (2-2) Demographics of Each Group

Attribute information (demographics) of each group was examined.

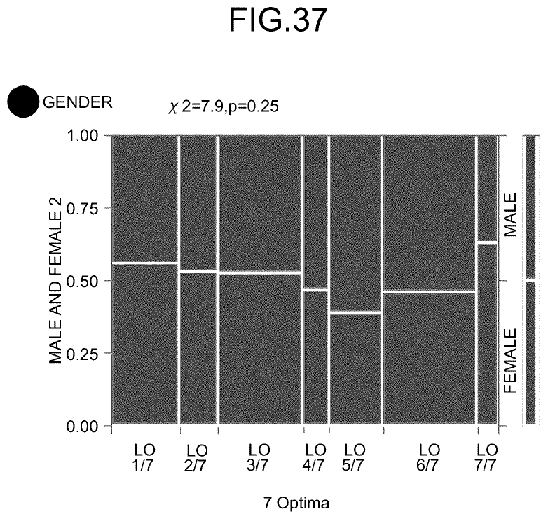

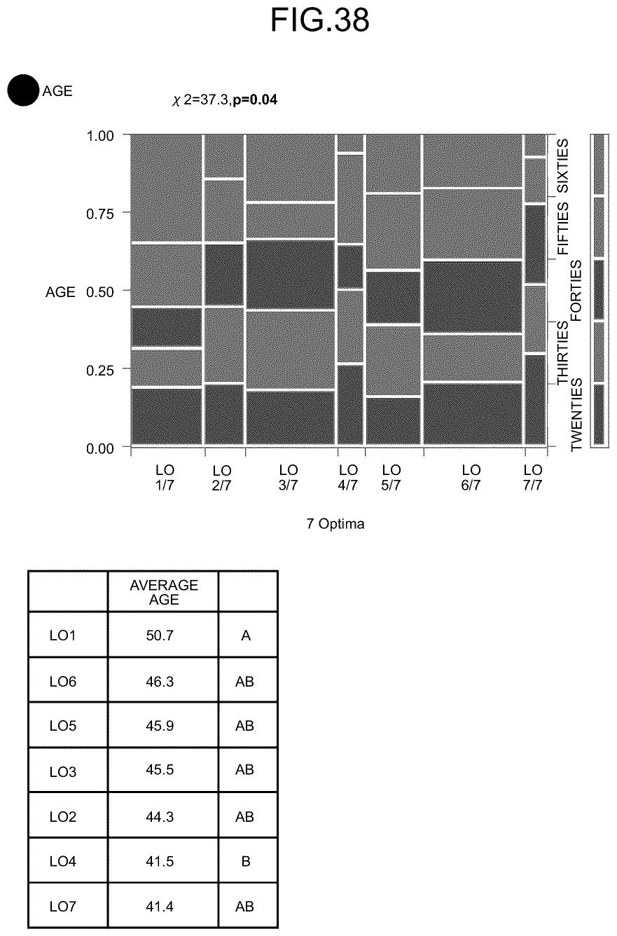

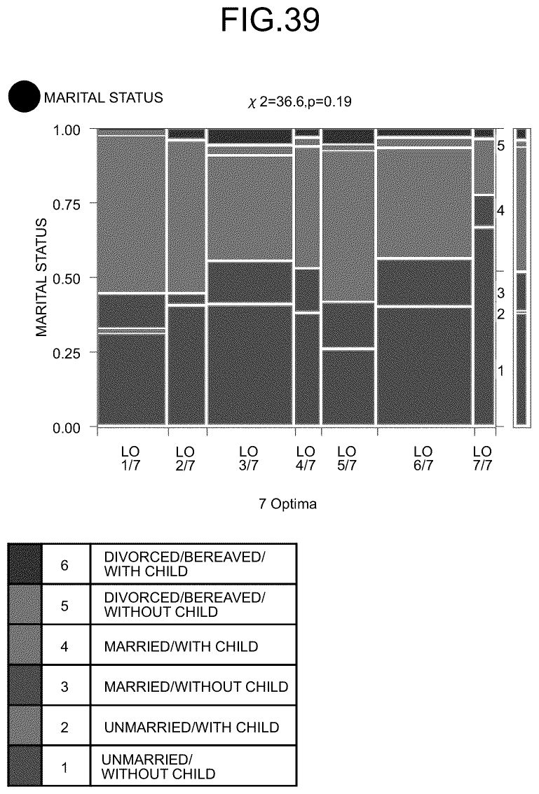

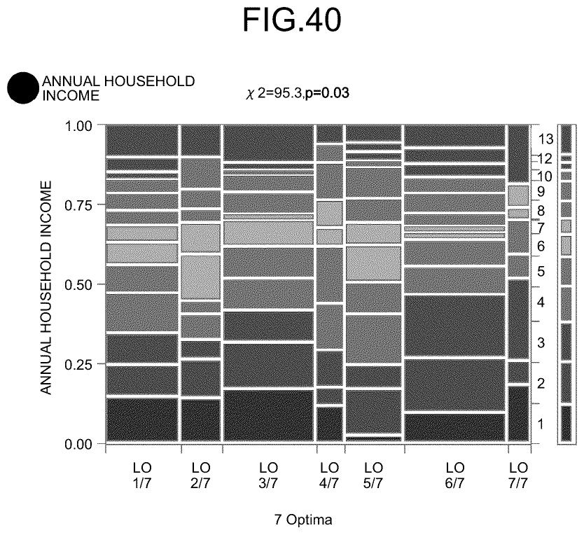

FIG. 37 to FIG. 40 indicate results of examining the demographics for the respective groups (LO1 to LO7). FIG. 37 is an examination result of the genders in each group. FIG. 38 is an examination result of an age of each group. FIG. 39 is an examination result of a marital status of each group. FIG. 40 is an examination result of an annual household income of each group.

As indicated by the graph in FIG. 38, a ratio of people in sixties was high in LO1, and in contrast, a ratio of people in sixties was low in LO4. An average age of LO1 was higher than an average age of LO4.

As indicated by the graph in FIG. 39, a ratio of “unmarried, no child” was high in LO7.

As indicated by the graph in FIG. 40, a ratio of a household income equal to or more than 12 million yen (“12” on a right bar) was high in LO1. As indicated by the graph in FIG. 40, a ratio of a household income less than 6 million yen (“1” to “6” on the right bar) was high in LO3 and LO6. In FIG. 40, “13” on the right bar means “I don't know/I don't want to tell”.

### (2-3) Food Consciousness of Each Group

Food consciousness of each group was examined.

Each of the groups (LO1 to LO7) answered to the following seven questionnaire items related to food consciousness with “Yes (applied)” or “No (not applied)”.
(Item 1) I am particular about selecting food items and cooking.
(Item 2) I use pesticide-free and organic agricultural products by choice.
(Item 3) I purchase a topical cooked product or food even if it is a little expensive.
(Item 4) I'm interested in eating and tasty restaurants.
(Item 5) I have purchased a perishable product via the Internet.
(Item 6) I want to eat more vegetables for nutrient balance.
(Item 7) I willingly collect information about a healthy meal.

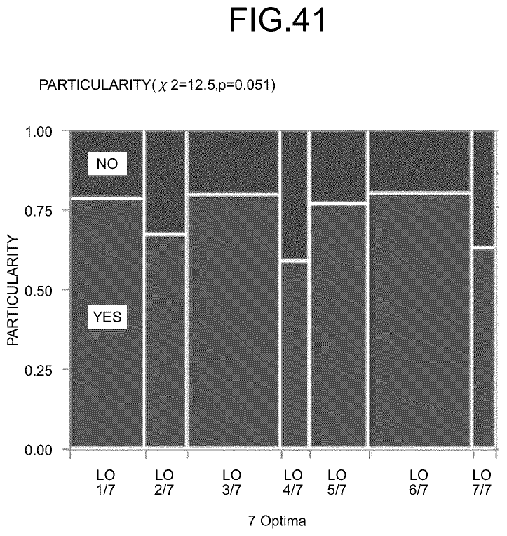

FIG. 41 to FIG. 47 indicate results of answers to Item 1 to Item 7.

As illustrated in FIG. 41, a ratio of people who were particular about selecting food items and cooking (Item 1) was low in LO2, LO4, and LO7.

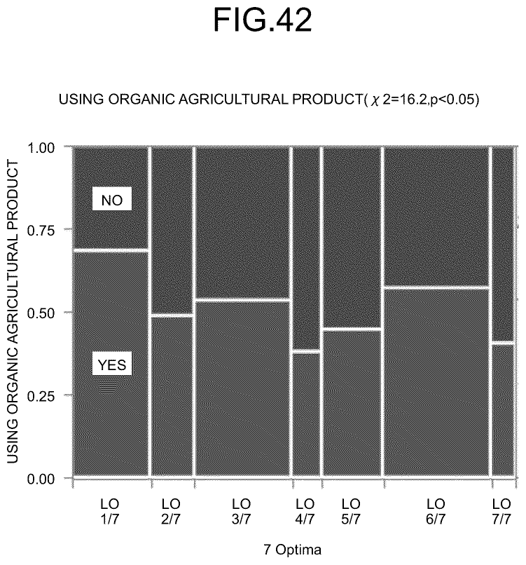

As illustrated in FIG. 42, a ratio of people who used pesticide-free and organic agricultural products by choice (Item 2) was low in LO2, LO4, and LO7.

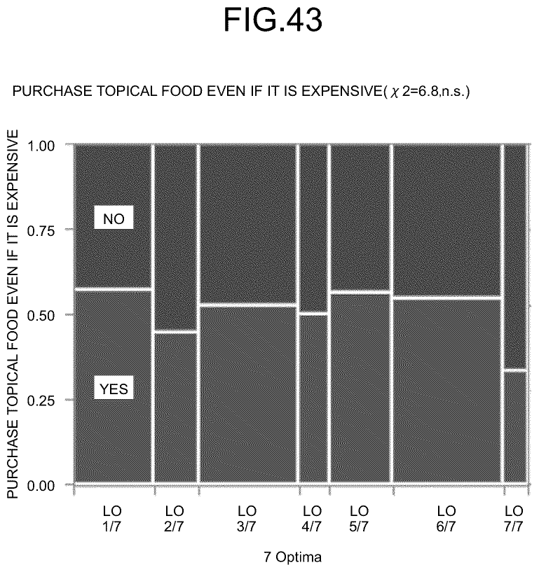

As illustrated in FIG. 43, there was no significant difference among the groups in a ratio of people who purchased a topical product (Item 3).

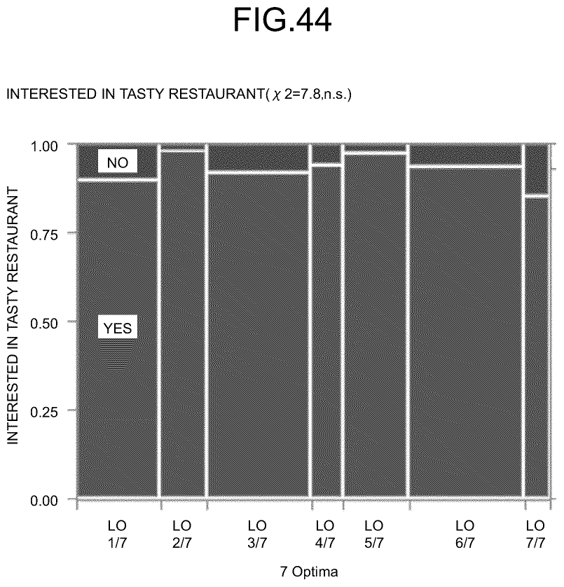

As illustrated in FIG. 44, there was no significant difference among the groups in a ratio of people who were interested in tasty restaurants (Item 4).

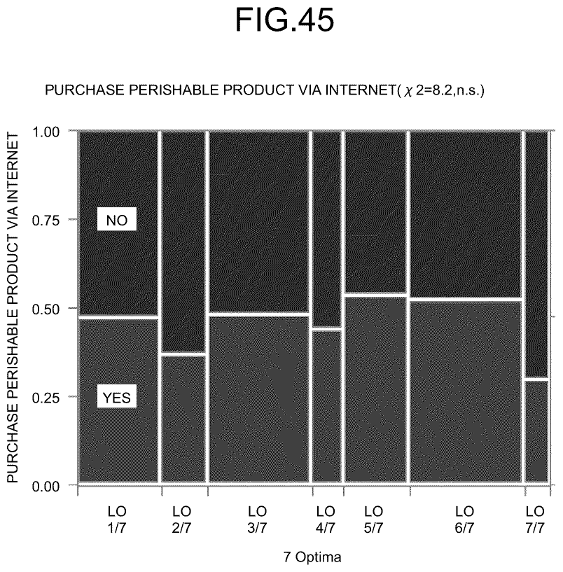

As illustrated in FIG. 45, a ratio of people who had purchased a perishable product via the Internet (Item 5) was low in LO2, LO4, and LO7.

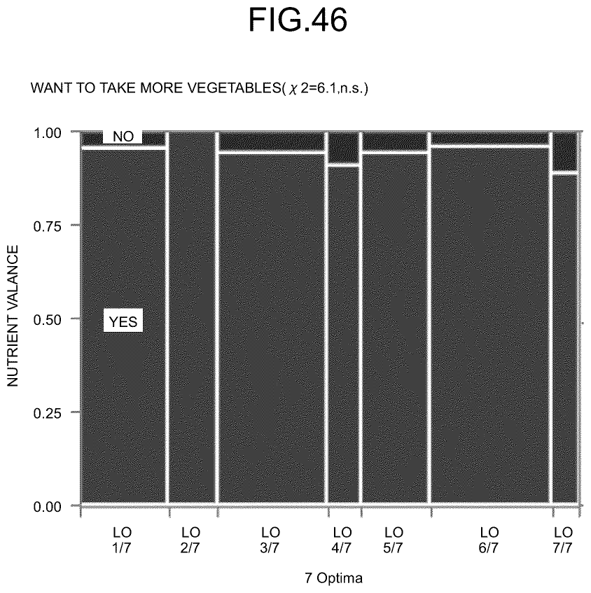

As illustrated in FIG. 46, there was no significant difference among the groups in a ratio of people who wanted to eat more vegetable (Item 6).

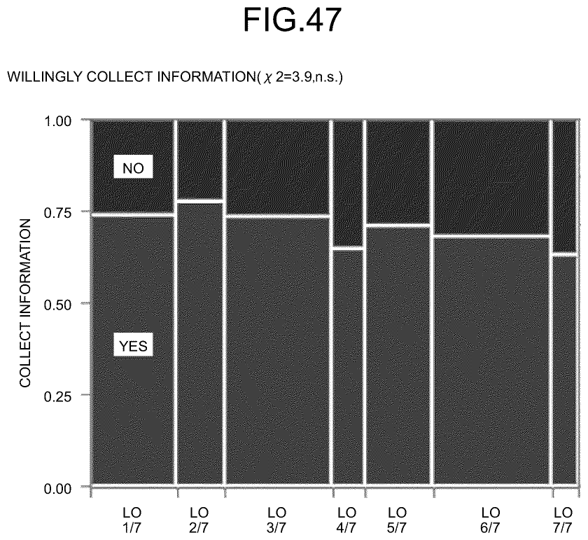

As illustrated in FIG. 47, there was no significant difference among the groups in a ratio of people who willingly collected information (Item 7).

### Step S4: Estimation of Object

This section describes how the object estimating unit 102d estimates a vegetable for which the preference estimation person has a high preference based on the preference space model generated at Step S1. The processing described in this section corresponds to Step S4 in FIG. 2.

First, a certain person (preference estimation person) who did not participate in the questionnaire at Step S1 was caused to answer to Q1 (question about preferences for the vegetables) in the questionnaire at Step S1.

The object estimating unit 102d estimated the vegetable for which the certain person had a high preference as follows using a result of the questionnaire, based on the preference space model generated at Step S1.

That is, the object estimating unit 102d compared the answer result of Q1 in the questionnaire conducted for the certain person with the answer result of Q1 in the questionnaire conducted for the 500 respondents at Step S1. As a result, 23 people of the 500 people had a high correlation with the certain person.

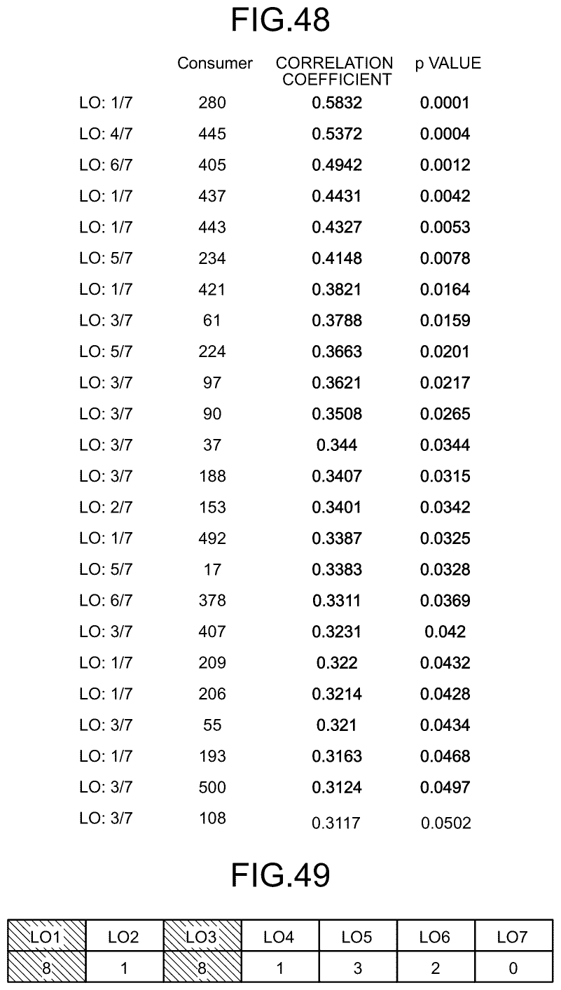

FIG. 48 indicates groups, Customer IDs, correlation coefficients, and p values for the 23 people. FIG. 49 indicates the groups to which the 23 people belong. A person who had the highest correlation with the certain person was a woman of Customer ID=280 as illustrated in FIG. 48.

As illustrated in FIG. 49, of the 23 people each having a high correlation, eight people belonged to the group of LO1, one person belonged to the group of LO2, eight people belonged to the group of LO3, one person belonged to the group of LO4, three people belonged to the group of LO5, two people belonged to the group of LO6, and 0 people belonged to the group of LO7. Due to this, the object estimating unit 102d specified LO1 and LO3 as groups having a preference similar to the preference of the certain person.

The object estimating unit 102d then estimated a vegetable for which LO1 and LO3 as the specified groups had a high preference as a vegetable for which the certain person had a high preference. Details about the vegetables for which each group has a high preference are described in (2-1) at Step S3.

### Step S5: Estimation of Person

This section describes how the person estimating unit 102e estimates the person who prefers the preference estimation object based on the preference space model generated at Step S1 and the correlation calculated at Step S2. The processing described in this section corresponds to Step S5 in FIG. 2.

As vegetables (preference estimation objects) that were not the subjects of the questionnaire at Step S1, four types of vegetables including Japanese parsley (Seri), cauliflower (Cali), kale (Kale), and zucchini (Zucch) were used. Nutrient components of the four types of vegetables were examined.

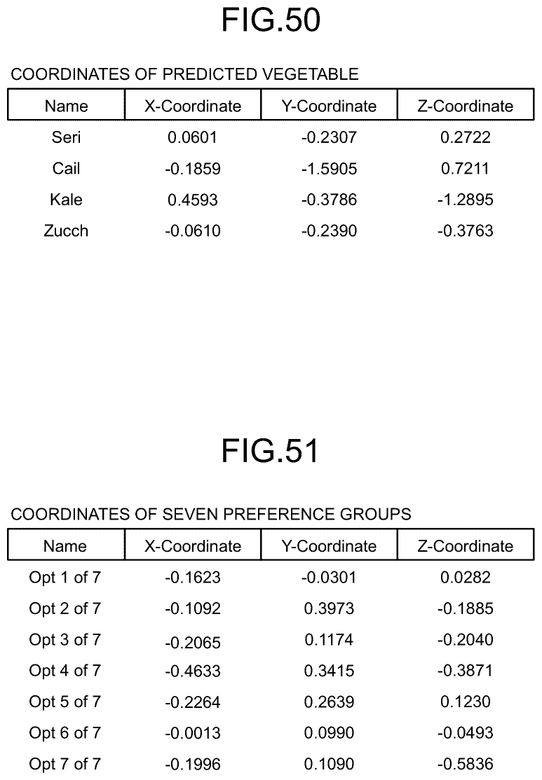

The person estimating unit 102e obtained space coordinates of points representing the four types of vegetables in the preference space model generated at Step S1 using the nutrient components of the four types of vegetables based on the correlation coefficients between the nutrient components and the vegetables calculated at Step S2 (refer to FIG. 23). The space coordinates of the points representing the four types of vegetables are illustrated in FIG. 50.

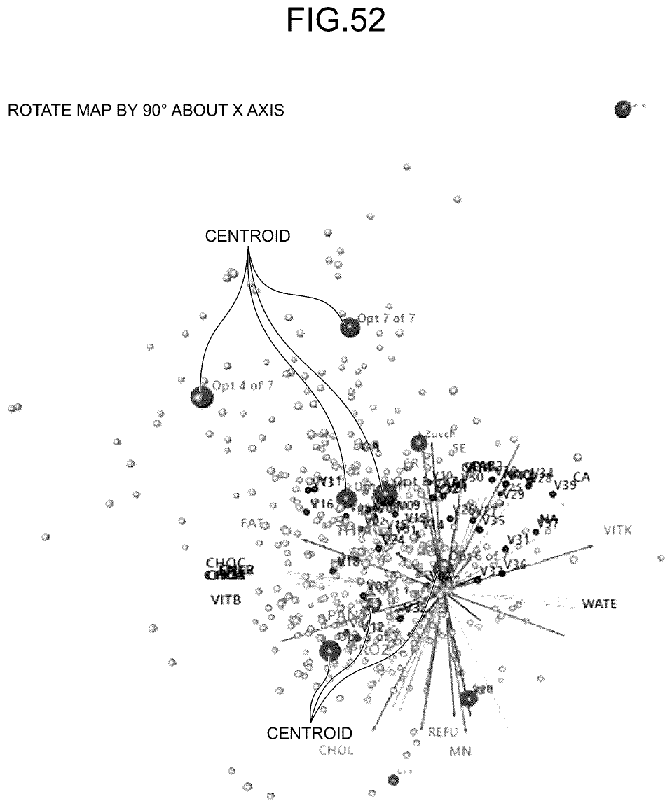

Subsequently, the person estimating unit 102e specified which of the centroids of the seven groups obtained at Step S3 is closest to each pair of the obtained space coordinates of the points representing the four types of vegetables. FIG. 51 indicates the space coordinates of the centroids of the seven groups. The centroids of the seven groups are indicated on the preference space model in FIG. 52.

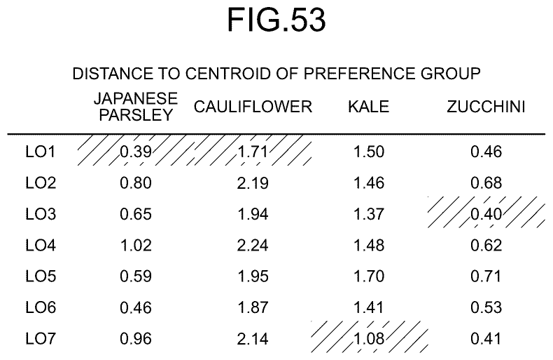

As a result, as illustrated in FIG. 53, the person estimating unit 102e specified that Japanese parsley (Seri) was closest to the centroid of the group of LO1 (distance: 0.39), kale (Kale) was closest to the centroid of the group of LO7 (distance: 1.08), and zucchini (Zucch) was closest to the centroid of the group of LO3 (distance: 0.40). Although cauliflower (Cali) was closest to the centroid of the group of LO1 (distance: 1.71), the distance was 1.71, which was large.

Accordingly, the person estimating unit 102e estimated that a person who preferred Japanese parsley (Seri) was a person belonging to the group of LO1, a person who preferred kale (Kale) was a person belonging to the group of LO7, and a person who preferred zucchini (Zucch) was a person belonging to the group of LO3. The distance between cauliflower (Cali) and the centroid was large, so that the person estimating unit 102e estimated that there was no group preferring cauliflower (Cali) in the seven groups.

### Step S6: Presentation of Attribute Information and Food Consciousness Information

This section describes presentation of the attribute information (demographics) and the food consciousness information by the attribute/food consciousness presenting unit 102f in detail. The processing described in this section corresponds to Step S6 in FIG. 2.

The attribute/food consciousness presenting unit 102f may present the demographics and the food consciousness information for the groups specified at Step S4 or S5 together. Details about the demographics of the respective groups are described in (2-2) at Step S3, and details about the food consciousness information of the respective groups are described in (2-3) at Step S3.

The following describes a case of Step S4. At Step S4, the object estimating unit 102d specified LO1 and LO3 as the groups having the preference similar to that of the preference estimation person. Thus, the attribute/food consciousness presenting unit 102f may present the demographics and the food consciousness information for the specified groups together. At Step S4, the object estimating unit 102d specified the woman of Customer ID=280 as a person having a preference closest to the preference of the certain person. Thus, the attribute/food consciousness presenting unit 102f may present the demographics and the food consciousness information for the woman of Customer ID=280 together.

The attribute/food consciousness presenting unit 102f may present senses preferred by the specified groups and nutrient components that tend to be insufficient for the specified groups together.

The following describes a case of Step S5. At Step S5, the person estimating unit 102e specified, as groups that preferred the preference estimation object, the group of LO1 for Japanese parsley (Seri), the group of LO7 for kale (Kale), and the group of LO3 for zucchini (Zucch). Thus, the person estimating unit 102e may present the demographics and the food consciousness information for the specified groups together.

The attribute/food consciousness presenting unit 102f may present vegetables greatly preferred by the specified groups. Specifically, the person estimating unit 102e may present “Welsh onion, lettuce” as vegetables greatly preferred by the group of LO1, and present “pumpkin” as a vegetable greatly preferred by the group of LO3. There is no vegetable greatly preferred by the group of LO7, so that the attribute/food consciousness presenting unit 102f does not present a vegetable greatly preferred by the group of LO7.

### 3. Summary of Present Embodiment

As described above, according to the present embodiment, as mainly described in [Step S4: Estimation of object], a vegetable suitable for a preference of a certain person (preference estimation person) can be estimated by using the preference space model according to the present embodiment. By using the preference space model, a commodity suitable for a preference can be provided only by causing a customer to answer a simple questionnaire in a store and the like. The preference estimation apparatus 100 can be used for sales promotion and the like by installing the device in a store front, for example.

According to the present embodiment, as mainly described in [Step S5: Estimation of person], a person who prefers a certain vegetable (preference estimation object) can be estimated by using the preference space model according to the present embodiment. Additionally, whether a new vegetable is suitable for a preference of a person belonging to a certain group can be estimated.

According to the present embodiment, when a person tries to select a commodity, a commodity suitable for a preference of the person can be suggested by using the preference space model even when there is no past purchase information of the person.

According to the present embodiment, in selling commodities, even for a completely new commodity for which there is no past purchase information, a distributor can estimate an object person who would like the commodity or a group that would like the commodity.

According to the present embodiment, preferences of people for objects and demographics (proper information of the people) can be analyzed, so that marketing information is not only obtained but also associated with objective information of the objects. Accordingly, more detailed information analysis can be performed, and appropriate suggestion and communication are enabled for customers.

### 4. Other Embodiments

The present invention may be implemented by various different embodiments in addition to the embodiment described above within a range of technical ideas of the claims.

For example, among the pieces of processing described in the embodiment, all or part of the pieces of processing described to be automatically performed can be manually performed, or all or part of the pieces of processing described to be manually performed can be automatically performed by a well-known method.

The processing procedures, control procedures, specific names, information including registration data of each piece of processing and parameters such as search conditions, screen examples, and database configurations described in the specification or illustrated in the drawings can be optionally changed unless otherwise specifically noted.

The components of the preference estimation apparatus 100 illustrated in the drawings are merely conceptual, and it is not required that they are physically configured as illustrated necessarily.

For example, all or optional part of processing functions of the preference estimation apparatus 100, especially processing functions executed by the control unit, may be implemented by a CPU and a computer program interpreted and executed by the CPU, or may be implemented as hardware using wired logic. The computer programs are recorded in a non-transitory computer-readable recording medium including programmed commands for causing an information processing apparatus to perform the processing described in the present embodiment, and are mechanically read by the preference estimation apparatus 100 as needed. That is, in a storage unit and the like such as a ROM or a hard disk drive (HDD), a computer program is recorded for giving commands to the CPU in cooperation with an OS to perform various kinds of processing. The computer program is executed by being loaded into a RAM, and constitutes the control unit in cooperation with the CPU.

The computer program may be stored in an application program server that is connected to the preference estimation apparatus 100 via an optional network, and can be entirely or partially downloaded as needed.

The computer programs for executing the processing described in the present embodiment may be stored in a non-transitory computer-readable recording medium, or may be configured as a computer program product. This “recording medium” encompasses an optional “portable physical medium” such as a memory card, a Universal Serial Bus (USB) memory, a Secure Digital (SD) card, a flexible disk, a magneto-optical disc, a ROM, an Erasable Programmable Read Only Memory (EPROM), an Electrically Erasable and Programmable Read Only Memory (EEPROM) (registered trademark), a Compact Disk Read Only Memory (CD-ROM), a Magneto-Optical disk (MO), a Digital Versatile Disk (DVD), and a Blu-ray (registered trademark) Disc.

The “computer program” is a data processing method described by using an optional language or a description method, and any format such as a source code or a binary code may be used. The “computer program” is not limited to a singly configured computer program, but encompasses a computer program configured to be distributed as a plurality of modules or libraries, and a computer program that implements its function in cooperation with a separate computer program represented by an OS. As a specific configuration and a reading procedure for reading a recording medium by each apparatus described in the embodiment, an installation procedure after reading, and the like, a known configuration or procedure can be used.

Various databases and the like stored in the storage unit are storage units including a memory device such as a RAM and a ROM, a fixed disk device such as a hard disk, a flexible disk, and an optical disc, and store various computer programs, tables, databases, files for Web pages, and the like used for various kinds of processing or for providing a Web site.

The preference estimation apparatus 100 may be configured as an information processing device such as a known personal computer or workstation, or may be configured as the information processing apparatus to which an optional peripheral device is connected. The preference estimation apparatus 100 may be implemented by implementing software (including a computer program, data, and the like) for causing the apparatus to implement the processing described in the present embodiment.

Additionally, specific forms of distribution and integration of the devices are not limited to those illustrated in the drawings. All or part thereof may be functionally or physically distributed/integrated in arbitrary units depending on various loads or functional loads. That is, the embodiments may be optionally combined to be performed, or the embodiments may be selectively performed.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A preference estimation method comprising:
a model generating step of generating, using preference information as information representing a preference of a person for an object, a preference space model as a model that includes a plurality of points each representing the object and a plurality of points each representing the person in a three-dimensional space and represents that a preference of the person for the object is higher as a distance between the point representing the object and the point representing the person is shorter; and
an object estimating step of estimating, using the preference information about a preference estimation person as a person whose preference is estimated, an object for which the preference estimation person has a high preference, based on the preference space model.

2. The preference estimation method according to claim 1, wherein
the points each representing the person are classified into a plurality of groups in the preference space model, and
at the object estimating step,
a group having a highest correlation with the preference of the preference estimation person is specified from the groups using the preference information about the preference estimation person, and an object for which the specified group has a high preference is estimated to be the object for which the preference estimation person has a high preference.

3. The preference estimation method according to claim 1, further comprising:
a correlation calculating step of calculating a correlation between the point representing the object in the preference space model and objective information as objective information about the object; and
a person estimating step of estimating, using the objective information about a preference estimation object as an object as a target for estimating a person who prefers the object, a person who prefers the preference estimation object, based on the correlation and the preference space model.

4. The preference estimation method according to claim 3, wherein
the points each representing the person are classified into a plurality of groups, and space coordinates of a centroid of each of the groups are obtained in the preference space model, and
at the person estimating step,
space coordinates of a point representing the preference estimation object in the preference space model are obtained based on the correlation using the objective information about the preference estimation object, a group with a centroid having the shortest distance to the obtained space coordinates is specified from the groups, and a person belonging to the specified group is estimated to be a person who prefers the preference estimation object.

5. The preference estimation method according to claim 3, wherein the objective information is at least one selected from the group consisting of a sense characteristic, a nutrient component, a physical characteristic, a biological characteristic, and a sociocultural characteristic of the object.

6. The preference estimation method according to claim 2, further comprising an attribute/food consciousness presenting step of presenting at least one of attribute information as information about an attribute of the person belonging to the specified group, and food consciousness information as information about food consciousness of the person belonging to the specified group.

7. The preference estimation method according to claim 6, wherein the attribute information is at least one selected from the group consisting of gender, an age, a place of residence, an economic situation, a health situation, household members, a marital status, presence/absence of a child, a school carrier, a knowledge level, a religion and an attitude, a belief, genetic information, disease information, a purchase history, a use situation of SNS, a job, nationality, a hometown, migration history information, a hobby, a homepage browse and communication history, tax payment information, vital information (invasive, noninvasive), amino index information (registered trademark), and an income.

8. The preference estimation method according to claim 1, wherein the preference information is a result of a questionnaire that examines the preference of the person for the object as a score.

9. The preference estimation method according to claim 1, wherein the object is a food.

10. The preference estimation method according to claim 9, wherein the food is a vegetable, a seasoning, a processed food, or a beverage.

11. A preference estimation apparatus comprising a control unit, wherein
the control unit includes:
a model generating unit that generates, using preference information as information representing a preference of a person for an object, a preference space model as a model that includes a plurality of points each representing the object and a plurality of points each representing the person in a three-dimensional space and represents that a preference of the person for the object is higher as a distance between the point representing the object and the point representing the person is shorter; and
an object estimating unit that estimates, using the preference information about a preference estimation person as a person whose preference is estimated, an object for which the preference estimation person has a high preference, based on the preference space model.

12. The preference estimation apparatus according to claim 11, wherein
the control unit further includes:
a correlation calculating unit that calculates a correlation between the point representing the object in the preference space model and objective information as objective information about the object; and
a person estimating unit that estimates, using the objective information about a preference estimation object as an object as a target for estimating a person who prefers the object, a person who prefers the preference estimation object, based on the correlation and the preference space model.

13. A preference estimation program to be executed by an information processing device including a control unit, the preference estimation program comprising:
a model generating step of generating, using preference information as information representing a preference of a person for an object, a preference space model as a model that includes a plurality of points each representing the object and a plurality of points each representing the person in a three-dimensional space and represents that a preference of the person for the object is higher as a distance between the point representing the object and the point representing the person is shorter; and
an object estimation step of estimating, using the preference information about a preference estimation person as a person whose preference is estimated, an object for which the preference estimation person has a high preference, based on the preference space model,
the steps being performed by the information processing device.

14. The preference estimation program according to claim 13, further comprising:
a correlation calculating step of calculating a correlation between the point representing the object in the preference space model and objective information as objective information about the object; and
a person estimating step of estimating, using the objective information about a preference estimation object as an object as a target for estimating a person who prefers the object, a person who prefers the preference estimation object based on the correlation and the preference space model,
the steps being performed by the information processing device.

15. A preference estimation method comprising:
a preference information acquiring step of acquiring preference information as information representing a preference of a person for an object about a preference estimation person as a person whose preference is estimated; and
an object estimating step of estimating an object for which the preference estimation person has a high preference using the preference information about the preference estimation person acquired at the preference information acquiring step based on a preference space model generated by using preference information as information representing a preference of a person for an object, the preference space model including a plurality of points each representing the object and a plurality of points each representing the person in a three-dimensional space and representing that the preference of the person for the object is higher as a distance between the point representing the object and the point representing the person is shorter.

16. A preference estimation method comprising:
a correlation calculating step of calculating, based on a preference space model generated by using preference information as information representing a preference of a person for an object, the preference space model including a plurality of points each representing the object and a plurality of points each representing the person in a three-dimensional space and representing that the preference of the person for the object is higher as a distance between the point representing the object and the point representing the person is shorter, a correlation between a point representing the object in the preference space model and objective information as objective information about the object; and
a person estimating step of estimating, using the objective information about a preference estimation object as an object as a target for estimating a person who prefers the object, a person who prefers the preference estimation object based on the correlation and the preference space model.

17. A preference estimation method comprising:
an object estimating step of estimating, based on a preference space model generated by using preference information as information representing a preference of a person for an object, the preference space model including a plurality of points each representing the object and a plurality of points each representing the person in a three-dimensional space and representing that the preference of the person for the object is higher as a distance between the point representing the object and the point representing the person is shorter using preference information about a preference estimation person as a person whose preference is estimated, an object for which the preference estimation person has a high preference.

18. A display method,
with a preference space model generated by using preference information as information representing a preference of a person for an object, the preference space model including a plurality of points each representing the object and a plurality of points each representing the person in a three-dimensional space and representing that the preference of the person for the object is higher as a distance between the point representing the object and the point representing the person is shorter, in which 1) the points each representing the person are classified into a plurality of groups, 2) space coordinates of a centroid of each of the groups are obtained, and 3) a correlation between the point representing the object and objective information as objective information about the object is calculated,
the display method comprising:
a person estimating step of obtaining, using the objective information about a preference estimation object as an object as a target for estimating a person who prefers the object, space coordinates of a point representing the preference estimation object in the preference space model based on the correlation, specifying a group with a centroid having the shortest distance to the obtained space coordinates from the groups, and estimating a person belonging to the specified group as a person who prefers the preference estimation object; and
an attribute/food consciousness presenting step of presenting at least one of attribute information as information about an attribute of the person belonging to the specified group, and food consciousness information as information about food consciousness of the person belonging to the specified group.

19. A model generation method comprising:
a model generating step of generating, using preference information as information representing a preference of a person for an object, a preference space model that includes a plurality of points each representing the object and a plurality of points each representing the person in a three-dimensional space and represents that a preference of the person for the object is higher as a distance between the point representing the object and the point representing the person is shorter.

20. A preference information prediction method
with a machine learning model that predicts, from preference information as information representing a preference of a person for an object corresponding to each of some multiple types of objects among multiple types of predetermined objects, the preference information corresponding to each of multiple types of residual objects other than some multiple types of objects, the machine learning model being generated based on a supervised learning method using the preference information corresponding to each of the multiple types of predetermined objects,
the preference information prediction method comprising a preference information predicting step of predicting the preference information about a preference estimation person as a person whose preference is estimated corresponding to each of the multiple types of residual objects using the preference information about the preference estimation person corresponding to each of some multiple types of objects.

21. A model generation method comprising:
an object selecting step of selecting some multiple types of objects from multiple types of predetermined objects; and
a model generating step of generating, based on a supervised learning method, a machine learning model that predicts preference information corresponding to each of multiple types of residual objects other than the selected objects from the preference information about each of the objects selected at the object selecting step using the preference information as information representing a preference of a person for an object corresponding to each of the multiple types of predetermined objects.

22. The model generation method according to claim 21, further comprising:
an MAE calculating step of calculating a mean absolute error with respect to a prediction result obtained by the machine learning model generated at the model generating step assuming that the preference information corresponding to each of the multiple types of residual objects is a correct answer, wherein
multiple types of objects are selected in descending order of the mean absolute error at the object selecting step.

23. The model generation method according to claim 21, further comprising:
a correlation coefficient calculating step of calculating a correlation coefficient of the preference information for each pair of objects using the preference information corresponding to each of the multiple types of predetermined objects, wherein
multiple types of objects are selected in ascending order of the correlation coefficient at the object selecting step.

24. The model generation method according to claim 22, further comprising:
a correlation coefficient calculating step of calculating a correlation coefficient of the preference information for each pair of objects using the preference information corresponding to each of the multiple types of predetermined objects, wherein
multiple types of objects are selected at the object selecting step by selecting multiple types of objects in descending order of the mean absolute error, selecting a pair of objects from the selected objects in descending order of the correlation coefficient, and excluding an object having a smaller mean absolute error from the selected pair of objects.

25. The model generation method according to claim 24, wherein attribute information as information about an attribute of a person is used in generating the machine learning model at the model generating step.

26. The model generation method according to claim 25, further comprising:
a sensitivity map creating step of creating a sensitivity map of a preference space model generated by using preference information as information representing a preference of a person for an object, the preference space model including a plurality of points each representing the object and a plurality of points each representing the person in a three-dimensional space and representing that the preference of the person for the object is higher as a distance between the point representing the object and the point representing the person is shorter, wherein
the attribute information used in generating the machine learning model at the model generating step is gender and an age, and
multiple types of objects are selected at the object selecting step by selecting an object to be excluded based on the sensitivity map, selecting multiple types of objects in descending order of the mean absolute error from the multiple types of predetermined objects from which the selected object has been excluded, selecting a pair of objects in descending order of the correlation coefficient from the selected objects, and excluding an object having a smaller mean absolute error from the selected pair of objects.

27. The model generation method according to claim 21, wherein the supervised learning method corresponds to classification.

28. The model generation method according to claim 27, wherein the supervised learning method corresponds to a method of decision tree.

29. The model generation method according to claim 28, wherein the supervised learning method uses a method of gradient boosting.

30. The model generation method according to claim 29, wherein the supervised learning method is a Light Gradient Boosting Machine (LightGBM).
